(19) United States
(12) Patent Application Publication
(10) Pub. No.: US 2014/0297201 A1
(43) Pub. Date: Oct. 2, 2014

(54) COMPUTER-ASSISTED STRUCTURE IDENTIFICATION

(71) Applicants: Arno Knorr, Dusseldorf (DE); Aurelien Monge, Lausanne (CH); Markus Stueber, Bergisch Gladbach (DE); Pavel Pospisil, Grandson (CH)

(72) Inventors: Arno Knorr, Dusseldorf (DE); Aurelien Monge, Lausanne (CH); Markus Stueber, Bergisch Gladbach (DE); Pavel Pospisil, Grandson (CH)

(73) Assignee: PHILIP MORRIS PRODUCTS S.A., Neuchatel, ` (CH)

(21) Appl. No.: 14/114,240

(22) PCT Filed: Apr. 30, 2012
(86) PCT No.: PCT/EP12/57942

§ 371 Date: Feb. 13, 2014

(30) Foreign Application Priority Data
Apr. 28, 2011 (EP) 11003505.2
Jun. 27, 2011 (EP) 11005180.2

(51) Int. Cl. H01J 49/00

(52) U.S. Cl. CPC H01J 49/0036
USPC 702/28

(57) ABSTRACT

The invention relates to a method for analysing mass spectral data obtained from a sample in GC×GC (2-dimensional) mass spectrometry, comprising: (a) comparing mass spectral data of an analyte with mass spectral data of candidate compounds of known structure in a data library; (b) identifying a plurality of candidate compounds from the library based on similarities of mass spectral data; (c) predicting, for each candidate compound, a value of at least one analytical property using a quantitative model based on a plurality of molecular descriptors; and (d) calculating a match score for each candidate compound based on the value predicted in step (c) and a measured value of the analytical property for the analyte.

The present invention relates to an automated, computer-assisted method for identifying compounds according to mass spectral and chromatographic data obtained from a sample. In particular, the invention relates to methods for identifying compounds using two dimensional gas chromatography-mass spectrometry (GC×GC-MS), and processes for automating the interpretation of the mass spectral and chromatographic data obtained from such a method.

Mass spectrometry is an analytical tool that can be used to determine the molecular weights of chemical compounds and of their fragments by detecting the ionized compounds and fragments according to their mass-to-charge ratio (m/z). The molecular ions are generated by inducing either a loss or a gain of a charge by the chemical compounds, such as via electron ejection, protonation, or deprotonation. The fragment ions are generated by collision-induced or energy-induced dissociation. The resulting data are usually presented as a spectrum, a plot with m/z ratio on the x-axis and abundance of ions on the y-axis. Thus, this spectrum shows the distribution of m/z values in the population of ions being analyzed. This distribution is characteristic for a given compound. Therefore, if the sample is a pure compound or contains only a few compounds, mass spectrometry can reveal the identity of the compound(s) in the sample.

A complex sample usually contains too many chemical compounds to be analyzed meaningfully by mass spectrometry alone, because ionization of different chemical compounds may result in ions with the same m/z value. The more chemical compounds a sample contains, the more likely ions of the same m/z values will be generated from different compounds. Therefore, a complex sample is typically resolved to some extent prior to mass spectrometry, such as by liquid chromatography (LC), gas chromatography (GC), or capillary electrophoresis. For analysis of volatile compounds, gas chromatography is advantageously coupled with mass spectroscopy (GC-MS). Several ionization methods are available in GC, one of the most common being electron impact (EI), in which molecules are ionized by bombardment with electrons emitted by a filament.

During the sample separation step (chromatography), the chemical compounds in the sample are separated based on how long they stay in the sample separation system (column). Once a chemical compound exits the sample separation system, it enters a mass spectrometer system, and the ionization/ion separation/detection process begins as described above. For each compound, the time it remains in the sample separation system before it produces signal(s) in the mass spectrum is a function of its structure and is referred to as the retention time (RT). However, retention time is also specific to the instrument being used, and especially the column specifications in a gas chromatograph.

Without exact replication of the instrumentation on which RT is first measured, RTs of the same sample measured later may not match the RTs specified in the original chromatographic method or the computerized method files (including calibration and event tables) and can lead to misidentified peaks. One solution is the “relative retention” approach which utilizes retention indices (RI) or Kovats indices (KI) that circumvent problems associated with discrepancies in RT due to instrument-to-instrument or column-to-column variation. Methods to predict Kovats indices (KI) based on molecular structure and associated features are known in the art. Models which predict KI based on such factors are known as Quantitative Structure-Property Relationship (QSPR) models. See, for example, Mihaleva et al., (2009) Bioinformatics 6:787-794; Garjani-Nejad et al., (2004) Journal of Chromatography A, 1028:287-295; Seeley and Seeley, (2007) Journal of Chromatography A, 1172:72-83. This type of procedure converts the actual retention times of detected peaks into a number that is normalized to multiple reference compounds. This is especially useful for comparing retention times to databases and libraries for identification of individual components. Such libraries provide large numbers of known compounds, and a match between the data obtained experimentally by GC-MS and a compound in a library can assist in identification of the compound.

In order to increase the resolution of the GC-MS, a “second dimension” of GC can be added, for instance by coupling the GC column to a second GC column (often referred to as 2DGC-MS or GC×GC-MS, and used interchangeably here with the terms GC×GC-TOF or GC×GC-TOF-MS). See Venkatramani and Phillips, J. Microcolumn Sep. (1993) 5:511-516. Peaks of interest are diverted from the first column into the second column for further separation, which then feeds into the mass spectrometry system. However, even, GC×GC-MS relies on structural correlation with compound libraries to make identifications of unknown compounds. The libraries of compounds most widely used for structural identification, such as the NIST library, contain retention index information for only 9% of the compounds having mass spectral data. The use of RI or KI data allows structural assignments derived from comparison with library data to be refined. However, in order to achieve an acceptable level of confidence in the identification of an unknown compound, the assignment must be interpreted by the user, and compared to a reference standard by mass spectrometry to confirm the proposed structure. This approach has a number of disadvantages, including the need to repeat the process manually, which is inefficient; the limited size of Kovats Indices libraries; the lack of standardization, due to the need for manual intervention; all of which leads to reduced levels of confidence in the identification process.

In the traditional approach to identify the structure of a compound, mass spectral data generated by gas chromatography-electron impact ionization-mass spectrometry (GC-EI-MS) are compared with commercially available mass spectral data libraries (FIG. 1). Using this procedure, the identification has only a low confidence level. In order to increase the level of confidence, a manual verification and interpretation of the mass spectral library search is carried out and the experimental retention time, or the Kovats index, is compared to database entries (e.g., NIST Retention Index library). Finally, for compound identification, a confirmation with reference standards is required. However, owing to the fact that this is very costly and time demanding, it is currently carried out only for a limited number of compounds.

There is a great need, therefore, for an improved procedure for interpreting GC-MS data which will allow greater levels of automation in structure identification and greater levels of confidence in the result.

### SUMMARY OF THE INVENTION

In a first aspect, there is provided a method for analysing mass spectral data obtained from a sample in two dimensional gas chromatography-mass spectrometry (GC×GC-MS), comprising:
(a) comparing mass spectral data obtained from a sample comprising an analyte with mass spectral data of candidate compounds of known structure in a library;
(b) identifying a plurality of candidate compounds from the library based on similarities of mass spectral data;
(c) predicting, for each candidate compound, a value of at least one analytical property using a quantitative model based on a plurality of molecular descriptors; and
(d) calculating a match score for each candidate compound based on the value predicted in step (c) and a measured value of the analytical property for the analyte.

In various embodiments of the method, within step (c), an analytical property score is derived from the predicted value of the analytical property of a candidate compound and a measured value of the analyte. In step (d), the measured value of the analytical property for the analyte can be the spectral similarity value as determined by algorithms in the software to query a data library, such as those provided by NIST. The predicted value of an analytical property of a candidate compound is computed according to a quantitative model based on a plurality of molecular descriptors. Accordingly, in one embodiment, the quantitative model of step (c) can be established by:
(i) providing a set of training compounds of known structure and a set of test compounds of known structure, and optionally a set of validation compounds of known structure;
(ii) generating a measured value of an analytical property for each training compound, each test compound, and each validation compound;
(iii) for each training compound, computing a set of molecular descriptors based on chemical structure and properties;
(iv) selecting a set of molecular descriptors from the set of molecular descriptors for use in a quantitative model of the analytical property, by using a genetic algorithm;
(v) generating a plurality of proposed quantitative models using the selected set of molecular descriptors;
(vi) evaluating each proposed quantitative model by computing a predicted value of the analytical property for each test compound;
(vii) selecting the quantitative model according to the root mean square error (RMSE) and/or the squared correlation (r²) on the measured value and the predicted value of the analytical property for each test compound; and optionally
(viii) selecting the quantitative model according to the squared correlation (r²) on the measured value and the predicted value of the analytical property for each validation compound.

In various embodiments, the genetic algorithm used in step (iv) preferably comprises
(p) generating a plurality of candidate solutions using a combination of two or more molecular descriptors in a machine learning algorithm such as but not limited to multiple linear regression, k-nearest neighbour method, or support vector regression;
(q) scoring each candidate solution according to a fitness function based on the cross validation squared correlation (q²) of the training compounds;
(r) generating new candidate solutions by recombining and/or mutating the candidate solutions that produces an improving cross validation squared correlation; and
(s) repeating step (q) and (r) for a finite number of times, for example, from 10 to 50 generations.

Candidate solutions generated by different machine learning algorithms can be compared to identify the best performing solutions.

The establishment of a quantitative model for one or more analytical properties is performed at least once when a particular set up of a GC×GC-MS separation system (e.g., column specification, temperature profile, mobile phase) or mass spectrometry system is changed. After the quantitative models have been established for an experimental setup, it is not necessary to perform the same each time the data of an analyte generated by this particular set up is being analyzed.

The function of each analytical property, an analytical property score, is preferably calculated as a quadratic function, where for analytical property P,

y=1/(−((exp_{—}p−(exp_{—}p−(n1×SEP)))×exp_{—}p−(exp)p+(n1×SEP)))))×−((pre_{—}p−(exp_{—}p−(n1×SEP)))×(pre_{—}p−(exp_{—}p+(n1×SEP)))).

Exp_p=measured value of the property obtained by experiments, pre_p=predicted value of the property, and SEP=standard error or prediction. If the predicted and experimentally obtained measured values are identical, the equation=1. The SEP is calculated according to the formula, using the STEXY function of Microsoft Excel 2003:

$$\sqrt{\frac{1}{n 2} [ \sum {( y - \overline{y} )}^{2} - \frac{{[ \sum ( x - \overline{x} ) ( y - \overline{y} ) ]}^{2 }}{\sum {( x - \overline{x} )}^{2}} ]}$$

where x is a value of a sample, y is the predicted value of x for the sample and n is the number of samples.

In step (d) of the method, a spectral similarity value obtained from mass spectral database comparison can be used to generate a numerical value, wherein the spectral similarity value and the analytical property score(s) are combined. This numerical value is referred to herein as a match score, also referred to as the computer-assisted structure identification (CASI) score in the figures. In a preferred embodiment, the match score is calculated using a hyperbolic equation. The concept of the present invention differs from those used in currently available methods, in which analytical property values are used as a filter to select or deselect candidate compounds.

Optionally, for each query relating to a sample, the highest and second-highest match scores can be compared by dividing the highest score by the second-highest to generate a discrimination function, where a greater difference between the two scores generates a higher discrimination function. The higher the discrimination function, the higher the confidence score that can be assigned to each query. A confidence score can be calculated by multiplying the highest match score by the discrimination function value.

In preferred embodiments of the method, step (c) comprises predicting values of multiple analytical properties for each candidate compound. In one embodiment, a match score is derived from the spectral similarity obtained from the mass spectral database comparison, and a function of at least two analytical properties derived using a plurality of molecular descriptors. In another embodiment, a match score is derived from the spectral similarity value obtained from the mass spectral database comparison, and an analytical property score wherein the analytical property is the relative second dimension retention time derived by using a plurality of molecular descriptors.

Preferred analytical properties useful in the present invention include a Kovats index, a boiling point and a relative second dimension retention time (2D rel RT). If the predicted analytical properties used in the method of the invention comprise a Kovats index and a 2D rel RT, the Kovats index and relative 2D retention times are preferably calculated using different molecular descriptors. Preferably, all three preferred analytical properties are used.

The Kovats indices of compounds are predicted using a linear equation comprising a plurality of coefficients, each multiplied by the value of a molecular descriptor. The equation is preferably obtained by using a test data set and a genetic algorithm to select the molecular descriptors from a plurality of possible molecular descriptors, and a linear regression or k nearest neighbors learning algorithm to correlate the selected molecular descriptors with the value to predict.

The boiling points of compounds can be predicted based on experimentally determined Kovats indices. The boiling points of candidate compounds are calculated on the basis of their individual chemical structures using software packages known in the art, such as but not limited to ACD/PhysChem from Advanced Chemistry Development, Inc. (ACD/Labs, Toronto, Canada).

In methods known in the art, the second dimension retention times are absolute second dimension retention times and there is no known available method for calculating relative 2D retention times. The challenge for developing a relative model is to define a reference system that is accessible for all second dimension peaks. This problem is solved by referring to a hypothetical reference system that is based on a set of reference standards, for example, deuterated n-alkanes. Deuterated or isotopically labelled compounds can be used in a reference system for controlling retention times or internal standard-based quantification. Although other substances can be used as reference compounds, the n-alkanes are preferably used as a class of substances for generating a hypothetical 2D-RT reference system because this class of compounds does not have any known complex interaction with the stationary phase in the column of the second dimension separation system. Therefore this reference system adjusts for systemic shifts (such as different column length and gas flow), but not for analyte-stationary phase shifts, as these shifts are due to individual properties of the compounds. Therefore adjusting for systemic shifts is the preferred method with regard to robustness on adjusting the complete compound space. In one embodiment of the invention, the first dimension of the GC×GC-MS is separated in a non-polar environment and the second dimension is separated in a polar environment.

In accordance with the present invention, a relative second dimension retention time of a compound is advantageously calculated as a retention time relative to a hypothetical reference standard, for example, a n-alkane, whose retention time is derived from the regression function based on a series of reference standards, for example deuterated n-alkanes. The relative second dimension retention time of a compound is calculated as follows:

$$2 D - rel {RT}_{Comp} = \frac{abs 2 D {RT}_{Comp}}{2 D {RT}_{hypothetical reference}}$$

where 2D-rel RT_{comp} is the relative second dimension retention time of the compound; abs 2D RT_{comp} is the measured absolute second dimension retention time of the compound; and 2D RT_{hypothetical reference}, is calculated for each compound that elutes between reference standard compound 1 and compound 2, which can be for example deuterated n-alkanes:

$$2 D {RT}_{hypothetical n \text{-} alkane} = \frac{( 2 {DRT}_{dA 2} - 2 {DRT}_{dA 1} )}{( 1 D {RT}_{dA 2} - 1 D {RT}_{dA 1} )} \times 1 {DRT}_{Comp} + ( \frac{2 {DRT}_{dA 2} - ( 2 {DRT}_{dA 2} - 2 {DRT}_{dA 1} )}{1 {DRT}_{dA 2} - 1 {DRT}_{dA 1}} \times 1 {DRT}_{dA 1} )$$

where dA1 and dA2 are reference standard 1 and reference standard 2 (for example, deuterated n-alkane 1, and deuterated n-alkane 2); and 1DRT is the first dimension retention time of the respective molecules.

However, uin the above-described method, neither the absolute nor the relative second dimension retention times of candidate compounds are available. To use the relative second dimension retention time as an analytic property, a quantitative model is established using a set of training compounds, test compounds and optionally validation compounds.

In a second aspect of the invention, there is provided a method for calculating a relative second dimension retention time in GC×GC-MS (2-dimensional gas chromatography coupled to mass spectrometry) for a compound comprising the steps of:
(a) defining a reference system based on a function of deuterated n-alkanes that gives the hypothetical retention time of the reference for a range of retention times;
(b) transforming measured values of absolute second dimension retention times for a plurality of training compounds of known molecular structure into the reference system to calculate relative second dimension retention times for the training compounds;
(c) using the relative second dimension retention times for the training compounds to generate a quantitative structure-property relationship model of relative second dimension retention time based on a plurality of molecular descriptors;
(d) using the quantitative model to predict a relative second dimension retention time of the compound.

The quantitative model of relative second dimension retention time is established by:
(i) providing a set of training compounds of known structure and a set of test compounds of known structure, and optionally a set of validation compounds of known structure;
(ii) generating the measured value of the absolute second dimension retention time for each training compound, each test compound, and each validation compound in a specific experimental set up, and transforming these into the reference system to calculate relative second dimension retention times;
(ii) for each training compound, computing a set of molecular descriptors based on chemical structure and properties;
(iii) selecting a set of molecular descriptors from the set of molecular descriptors for use in a quantitative model of relative second dimension retention time, by using a genetic algorithm;
(iv) generating a plurality of proposed quantitative models using the selected set of molecular descriptors;
(v) evaluating each proposed quantitative model by computing a predicted value of relative second dimension retention time for each test compound
(vi) selecting the quantitative model according to the root mean square error (RMSE) and/or the squared correlation (r²) on the calculated value from step (iv) and the predicted value of the relative second dimension retention time for each test compound; and optionally
(vi) selecting the quantitative model according to the squared correlation (r²) on the calculated value and the predicted value of the second dimension retention time for each validation compound.

Preferably, the genetic algorithm used in this aspect of the invention comprises:
(p) generating a plurality of candidate solutions using a combination of two or more molecular descriptors in a machine learning algorithm such as but not limited to multiple linear regression, k-nearest neighbour method, or support vector regression;
(q) scoring each candidate solution according to a fitness function based on the cross validation squared correlation (q²) of the training compounds;
(r) generating new candidate solutions by recombining and/or mutating the candidate solutions that produces an improving cross validation squared correlation; and
(s) repeating step (q) and (r) for a finite number of times, for example, 10 to 50 generations.

Advantageously, the relative second dimension retention times used in the first aspect of the invention are predicted by the method of the second aspect of the invention.

Optionally, the results obtained from the computer-assisted methods of the invention based on chromatographic and mass spectral data generated by GC×GC-MS can be further enhanced by using the accurate mass data obtained from gas chromatograph-atmospheric pressure chemical ionization-mass spectrometry (GC-APCI-MS). Data generated by the two techniques can be matched by using a duplicate retention index system based on an additional reference system of deuterated fatty acid methyl esters.

In a third aspect, the invention provides methods for confirming the match of a test compound to a candidate compound identified in a database of two-dimension gas chromatography mass spectrometry. The methods comprise analysis of the same sample by gas chromatography by atmospheric pressure chemical ionization and time-of-flight mass spectrometry (GC-APCI-TOF-MS, GC-APCI-TOF, or GC-APCI-MS) and comparing the theoretical monoisotopic mass with the accurate mass measured by GC-APCI-TOF-MS. The prerequisite for the confirmatory method is to match the retention indices of the two different chromatographic systems. For example, the Kovats index system from GC×GC-TOF-MS analysis based on deuterated n-alkanes can be matched to another retention index system based on deuterated fatty acid methyl esters (FAMEs). The system based on deuterated FAMEs is used because deuterated n-alkanes are not ionizable by the ion source of the GC-APCI-TOF-MS.

The Kovats index systems are established by generation of a Kovats index system for GC×GC-TOF-MS system based on deuterated n-alkanes; analysis of deuterated FAMEs using the GC-GC-TOF-MS system and determination of the Kovats indices of the FAMEs; analysis of deuterated FAMEs using the GC-APCI-TOF-MS system and generation of a retention index system for GC-APCI-TOF-MS system based on deuterated FAMEs; and bridging of retention index system for GC-APCI-TOF-MS system based on deuterated FAMEs with the Kovats index system based on n-alkanes by using Kovats indices of deuterated FAMEs for GC×GC-TOF-MS system.

Accordingly, the invention provides methods comprising the steps of:

(a) measuring Kovats indices of analytes relative to a first set of reference compounds in GC×GC-TOF-MS;

(b) measuring Kovats indices of a second set of reference compounds relative to the first set of reference compounds in GC×GC-TOF-MS;

(c) measuring absolute retention times of the second set of reference compounds in a GC-APCI-TOF-MS; and

(d) using the Kovats indices of the second set of reference compounds measured in step (b) to derive by linear regression a function for converting the Kovats indices of the analytes measured in step (a) into estimated absolute retention times of the analytes in the GC-APCI-TOF-MS.

The function of step (d) is derived by linear regression for each retention time range where an analyte is detected between two adjacent reference compounds of the second set of reference compounds. The function is:

RT analytes in GC-APCI-TOF-MS=a (KI analytes in GC×GC-TOF-MS)+b, where a is a coefficient and b is constant for a specific time range.

The method further comprises comparing the molecular masses of the analytes with the molecular masses of the respective candidate compounds for each of the analytes.

In one embodiment, the method further comprises:

(e) measuring the absolute retention times of the analytes in the GC-APCI-TOF-MS;

(f) using the function calculated in step (d) to convert the absolute retention times measured in step (e) into calculated Kovats indices in the GC-APCI-TOF-MS for the analytes; and

(g) comparing the Kovats indices calculated in step (f) with the measured Kovats indices from step (a).

Preferably, the first set of reference compounds are deuterated n-alkanes. Preferably, the second set of reference compounds are deuterated fatty acids methyl esters.

### BRIEF DESCRIPTION OF THE DRAWINGS

Preferred embodiments of the present invention will now be described with reference to the accompanying drawings, in which:

FIG. 1 illustrates a traditional approach for compound structure identification using GC-MS (NO: no compound identified with medium confidence; YES: compound identified with medium confidence);

FIG. 2 illustrates the CASI approach for compound structure identification using GC×GC-MS system including use of GC-APCI-MS to confirm the results;

FIG. 3 illustrates a process used to build the Kovats index and relative second dimension retention time models;

FIG. 4 shows a correlation of predicted and experimental correlation values of Kovats Indices for a set of validation compounds;

FIG. 5 shows a correlation between boiling point (BP) predicted from Kovats Indices and BP predicted from chemical structures by software by ACD/Labs PhysChem for the set of validation compounds;

FIG. 6 shows a correlation between predicted retention times and experimental retention times for the external test set of the GC×GC-MS system second column retention time model;

FIG. 7 shows a contribution equation of a theoretical scoring module (e.g. fitting KI . . . );

FIG. 8 shows the result of CASI for furfural as presented by the computer system of the present invention;

FIG. 9 shows the position of the correct hit (i.e. structure candidate) for the 71 mass spectra to identify;

FIG. 10 shows an embodiment of a computer system according to the present invention;

FIG. 11 is a contingency table showing the true/false positives and true/false negatives rate for CASI and NIST search;

FIG. 12 shows a preferred embodiment of the CASI software architecture;

FIG. 13 shows web interface output showing for each structure to identify the structure candidate with the highest score is selected by default; and

FIG. 14 shows web interface output wherein user can change selection.

FIG. 15 shows the result on reproducibility (N=9) using the relative retention time model for the second dimension of GC×GC-TOF.

FIG. 16 shows the squared correlation for the selected relative 2DRT to be 0.855. The squared correlation at 0 intercept is consistent with a value of 0.853.

FIG. 17 shows the distribution of CASI scores for the correct hits of the validation set and of the hits selected by default (highest CASI score) for a set of 176 unknown compounds.

FIG. 18 shows the distribution of NIST Match Factors for the correct hits of the validation set and of the hits with highest NIST Match Factor for a set of 176 unknown compounds.

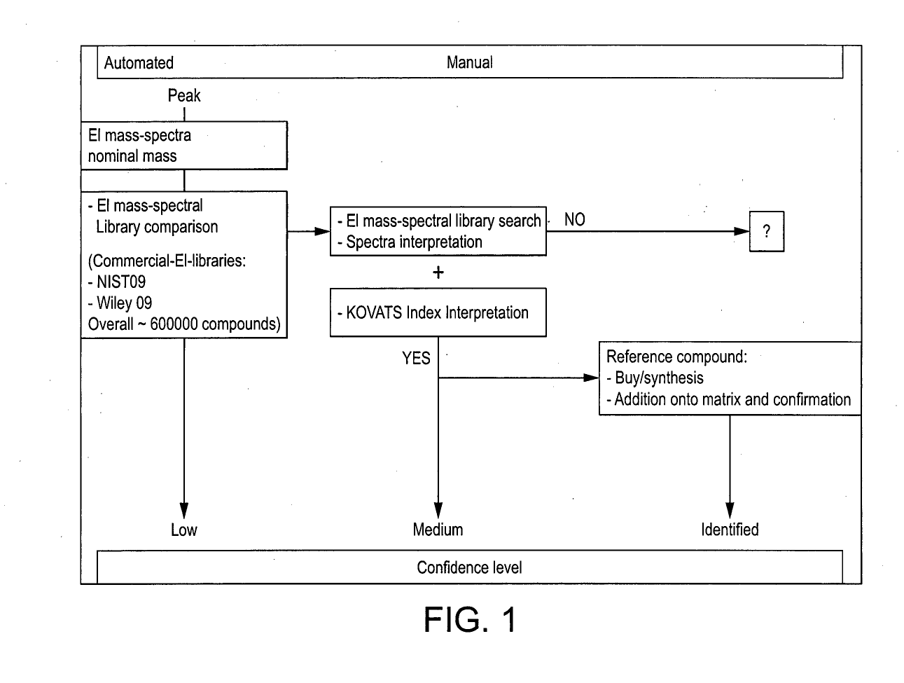

### DETAILED DESCRIPTION OF THE INVENTION

Unless defined otherwise, all technical and scientific terms used herein have the same meaning as commonly understood to one of ordinary skill in the art to which this invention belongs. Although any methods, devices and material similar or equivalent to those described herein can be used in the practice or testing of the invention, the preferred methods, devices and materials are now described.

All publications cited in this specification, including patent publications, are indicative of the level of ordinary skill in the art to which this invention pertains and are incorporated herein by reference in their entireties.

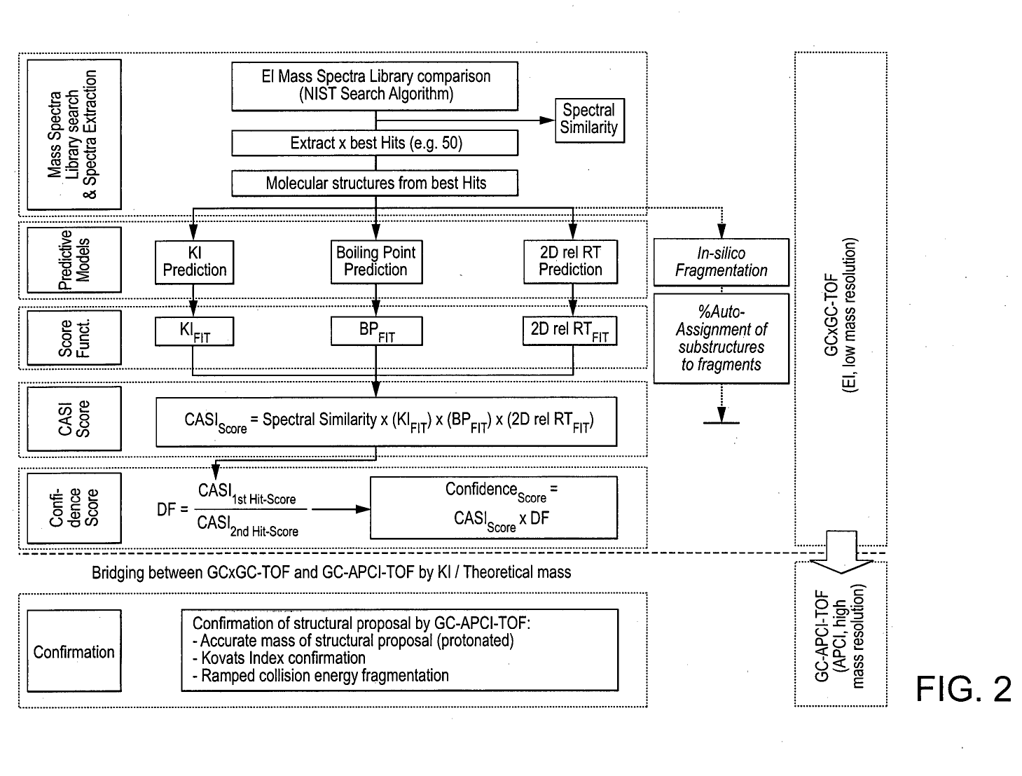

A high-throughput computer-assisted system for analyzing GC×GC-MS data, referred to as Computer-Assisted Structure Identification (CASI) is provided in this invention. The CASI system accelerates and standardizes the identification of compound structures, whilst assuring the reproducibility, and enables higher confidence for correct assignment of mass spectra to the right compounds. CASI is based on the generation of proposals for structural candidates by first querying a mass-spectral data library, followed by refinement of the matches by using orthogonal information derived from chromatographic and structural data as described in FIG. 2.

Firstly, mass spectra in data libraries or databases are searched for candidate compounds with similar mass spectra For example, an algorithm of National Institutes of Standards and Technology (NIST, Gaithersburg, Md., USA) MS Search and the NIST 08 or WILEY 9^{th} ed. Mass Spectra databases can be used which produce for each candidate structure a corresponding match factor. Other examples of data libraries include but are not limited to, NIST/EPA/NIH Mass Spectral Library; Wiley Registry of Mass Spectral Data, 9th Edition, F. W. McLafferty, Wiley; Mass Spectra of Volatile Compounds in Food, 2nd edition; Central Institute of Nutrition Food Research, Wiley-VCH; Mass Spectral Library of Drugs, Poisons, Pesticides, Pollutants and their Metabolites 2007, Hans H.; Pfleger Maurer, Karl; Weber, Armin A.; Mass Spectra of Geochemicals, Petrochemicals and Biomarkers, 2nd edition, J. W. De Leeuw; Mass Spectra of Organic Compounds, Alexander Yarkov. Mass Spectra of Androgens, Estrogens, and other Steroids 2010, M. K. Parr, G. Opfermann, W. Schanzer, H. L. J. Makin. Secondly, Quantitative Structure-Property Relationship (QSPR) models for the candidate compounds have been developed which predict analytic properties for each candidate compound in order to enhance the confidence in matching and compound identification. Two analytic properties, Kovats indices for first dimension (1D) separation and relative retention times for second dimension (2D) separation are predicted by using these models. Preferably, the Kovats indices and relative 2D RT are calculated using different molecular descriptors. In addition, a third analytic property, the boiling points of candidate compounds and the analyte. The boiling points are derived from the measured 1D RT of an analyte and are matched to computationally predicted boiling points of the candidate compounds. The boiling points can be calculated by software known in the art, such as ACD/PhysChem software. Finally, the CASI system combines for each candidate compound the matching result of NIST MS search and all parameters relating to the analytic properties predicted in QSPR models to produce a match score, also referred to as a CASI score (FIG. 2). False positive identifications are minimized by ensuring that absolute score values exceed a threshold. Optionally, the discriminatory power is calculated for each identified compound to measure confidence of the assignment. Optionally, the proposed chemical structure is confirmed by GC-APCI-TOF. The theoretical monoisotopic mass of these structural proposals can be compared with the accurate mass measured by GC-APCI-TOF-MS. The retention index data generated by the two techniques GC×GC-TOF and GC-APCI-TOF-MS can be matched by using the duplicate retention index system of deuterated n-alkanes as well as deuterated fatty acid methyl esters (FAMEs) for the GC×GC-TOF and deuterated FAMEs for GC-APCI-TOF-MS only. For the case of GC×GC-TOF the duplicate retention index system is for translation of Kovats Index (n-alkane) towards FAMEs retention index. For comparison between the instruments, the FAMEs retention index system can be used.

### the CASI System

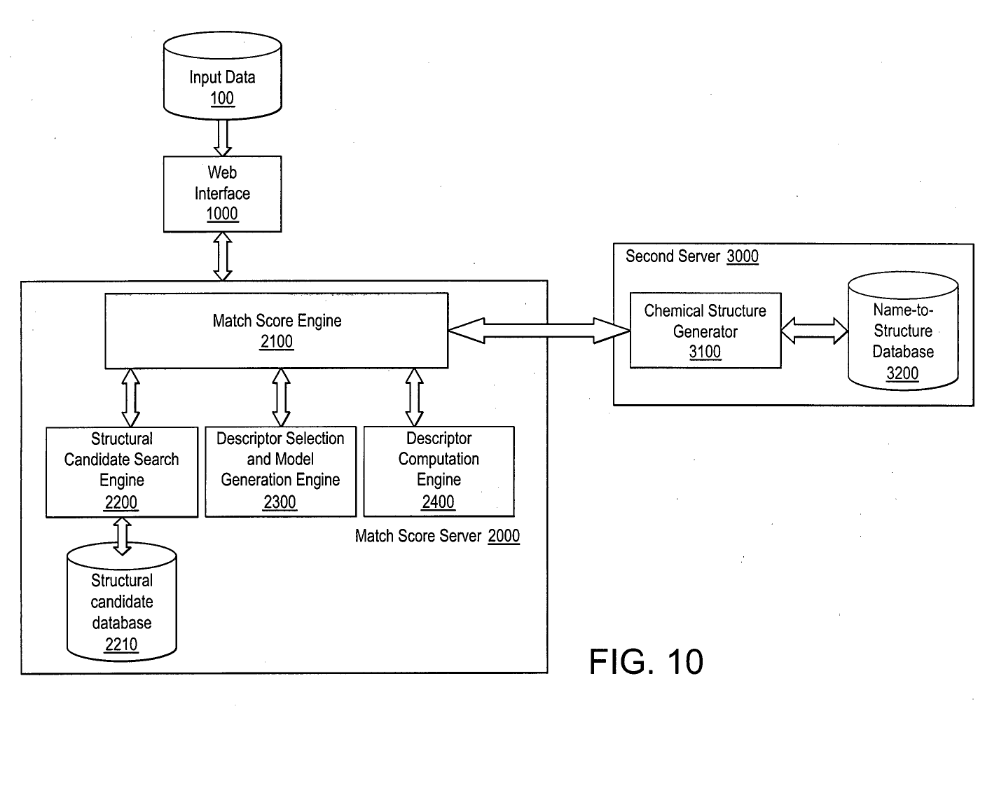

FIG. 10 is a block diagram of a computer system for analysing mass spectral data in GC×GC mass spectrometry. The system includes a web interface 1000, a match score generator engine 2100, a structural candidate search engine 2200 which accesses a structural candidate database 2210, a descriptor selection and model generation engine 2300 and a descriptor computation engine 2400. The system further includes a chemical structure generator 3100 which accesses a name-to-structure database 3200. The components of the system may be software applications operating on a single server or may be distributed over multiple computing systems communicating via network interfaces including wireless communication systems. However, in the embodiment shown in FIG. 10, the match score generator engine 2100, structural candidate search engine 2200, descriptor selection and model generation engine 2300 and descriptor computation engine 2400 are interconnected software applications operating on a match score server 2000, on which structural candidate database 2210 is also stored. The chemical structure generator 3100 and name-to-structure database 3200 operate on a second server 3000, although they may also operate on match score server 2000.

Input data 100 is input via web interface 1000. Input data may in the form of a JDX file, and comprises mass spectra data from a sample, and further include experimental values for analytical properties such as Kovats index data, and 2D retention time data. The web interface 1000 may communicate with the match score generator engine 2100 via a SOAP (Simple Object Access Protocol).

The computer system operates in two modes, a training mode and an analysis mode. The training mode may be run at any time, but it is necessary to run the computer system in training mode every time the gas chromatography-mass spectrometer experimental set up is changed. In the training mode, the input data are mass spectrometer data and measured values of an analytical property such as Kovats index, for a set of known compounds.

For each of the known compounds, the chemical structure in computer readable form is generated by the chemical structure generator 3100 which accesses the name-to-structure database 3200. The chemical structure generator 3100 may be Pipeline Pilot 7.5.1 software, and the database 3200 may be an ACD database.

For all of the known compounds, molecular descriptors are calculated by descriptor computation engine 2400, which may be the Dragon software package. The known compounds are divided into a training set and a test set. For the training set, descriptor selection and model generation engine 2300, which may be RapidMiner software, selects a set of predictive descriptors using forward selection and a genetic algorithm as described in detail above to construct a predictive model for predicting values of an analytical property, such as Kovats indices or 2D relative retention time, for the training compound structures. The predicted model is verified using the test set, as described in more detail above, and a model is selected.

In the analysis mode, the input data 100 is mass spectrometry data from a sample. The structural candidate search engine 2200 carries out a search in structural candidate database 2210 by comparing the mass spectra data from the sample with mass spectra data in the database 2210, to generate a number of structural candidate compounds based on similarity of the mass spectra data with the data in the database 2210. The selected candidate compounds may be, for example, the top 100 matches. The search engine may be an NIST MS search algorithm, and the database 2210 may be the NIST 08 and WILEY 9th ed Mass Spectra databases. The list of structural candidates is made available for the user to view via web interface 1000. Each candidate has a match factor indicative of the similarity of the mass spectra data for the sample with the data in the database 2210 for the candidate. The match factor is generated by the structural candidate search engine 2200, and may also be displayed to the user via the web interface 1000 for each structural candidate.

For each of the structural candidates, the chemical structure in computer readable form is generated by the chemical structure generator 3100 which accesses the name-to-structure database 3200. The chemical structure generator 3100 may be Pipeline Pilot 7.5.1 software, and the database 3200 may be an ACD database.

For all of the structural candidates, molecular descriptors are calculated by descriptor computation engine 2400, which may be the Dragon software package.

The model generated by the descriptor selection and model generation engine 2300 in the training mode is then used to predict the analytical property, such as Kovats index or 2D relative retention time, for the candidate structures. The descriptor selection and model generation engine 2300 supplies the model to the match score generator engine 2100 which calculates predicted values of one or more analytical properties based on the model. The predicted values may be communicated to the user via web interface 1000.

The match score generator engine 2100 calculates a match score for each candidate compound based on the match factors generated by the structural candidate search engine 2200, the predicted values of the analytical properties predicted by the model provided by the descriptor selection and model generation engine 2300, and measured values of the analytical properties of the sample which were included in input data 100. The match score generator engine 2100 may calculate a CASI score in accordance with the method described above. The match scores may also be communicated to a user via web interface 1000.

The web interface 1000 may display the results to the user in the form of a table, listing the structural candidates, the match factors generated by the structural candidate search engine 2200, the predicted values of the analytical properties generated by the model generation engine 2300, and the match score. The table may be sorted to rank the structural candidates by their match scores.

Once a model for predicting an analytical property has been generated by descriptor selection and model generation engine 2300 in the training mode, there is no need to generate a model again for a new set of input data i.e., a new sample for identification, and a new set of structural candidates, provided the experimental set up has not changed. If the experimental set up is changed, it is necessary to generate a new model by running the system in the training mode. Therefore, the descriptor selection and model generation engine 2300 supplies the selected model to the match score generator 2100, which, in the analysis mode, applies the model to the structural candidates to generate predicted values for the analytical property. In this way, in the analysis mode, access to the descriptor selection and model generation engine 2300 is not required. Access to the descriptor selection and model generation engine 2300 is only required in the training mode for generation of a new model. The descriptor selection and model generation engine 2300 may thus be provided on a separate computing device, for example, a server which is only accessed in the training mode.

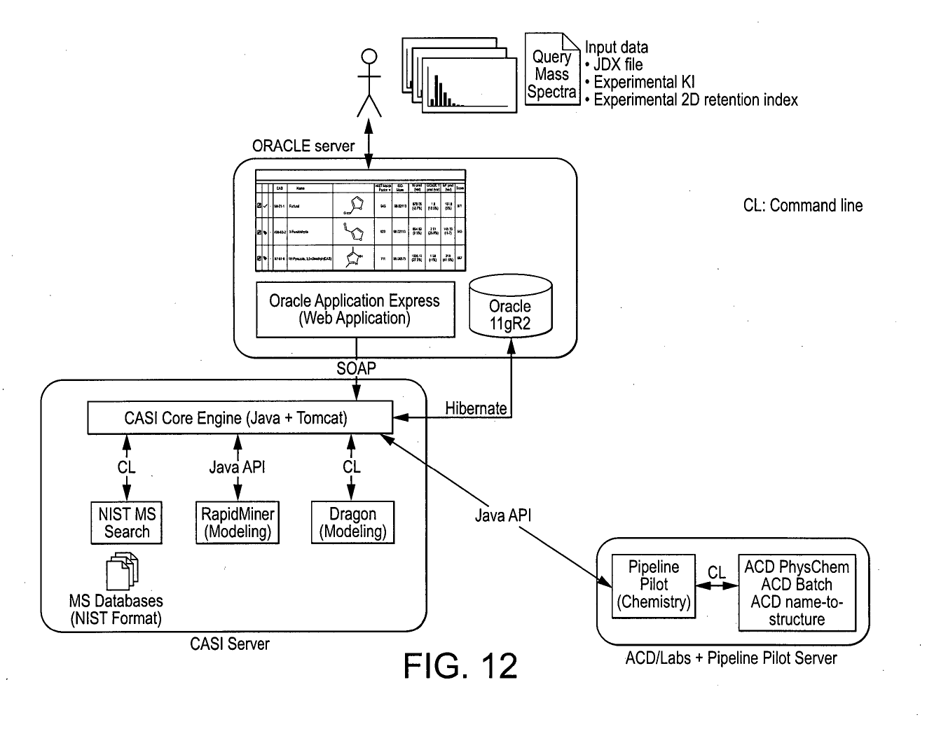

A preferred embodiment of the software architecture is illustrated in FIG. 12.

Oracle Application Express or similar software can be used for the development of the web interface 1000. For example, a SOAP interface allows Oracle Application Express to communicate with the match score generator engine 2100, which is developed in Java and runs in Tomcat. RapidMiner can be used as the descriptor selection and model generation engine 2300 and can be integrated by Java API. Java can be used to implement the match score generator engine 2100 mainly because RapidMiner can be easily integrated in Java.

The structural candidate search engine 2200 comprises the software for searching data libraries, for example, NIST MS Search which is integrated by command line. The chemical structure generator 3100 can be Pipeline Pilot and which can be integrated with Java API. It can be used to convert names of the hits to structures (using ACD/Labs name-to-structure and an internet connection to ChemBL), to standardize the structures, to compute boiling point (ACD/Labs PhysChem Batch) and to move data from CASI to a chemical registry database. The descriptor computation engine 2400 comprises a software package such as Dragon and is integrated by command line. In addition to these software modules, the standard Java APIs Log 4J is used for logging error messages, Hibernate can be used for the mapping of the objects to the Oracle database and JUnit is used for the unit tests.

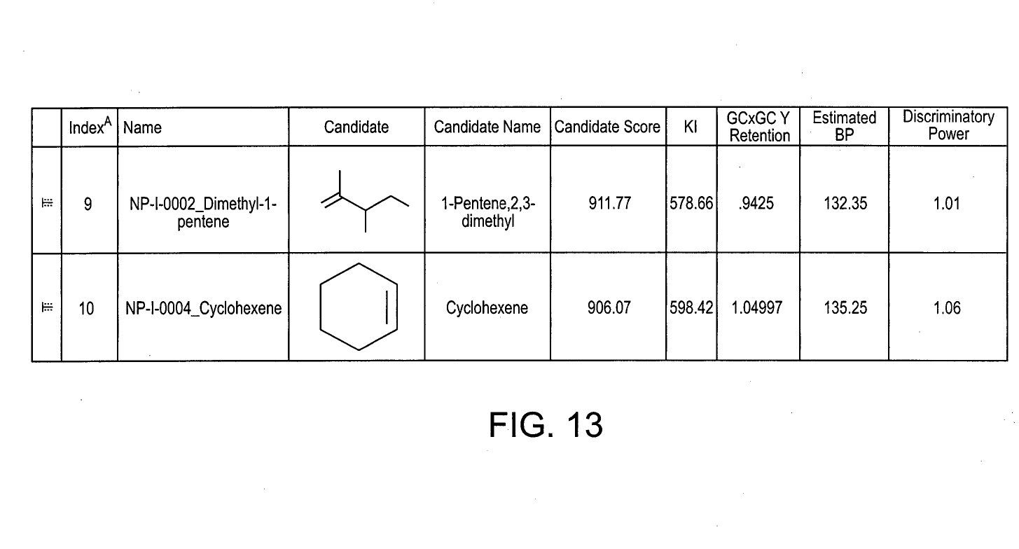

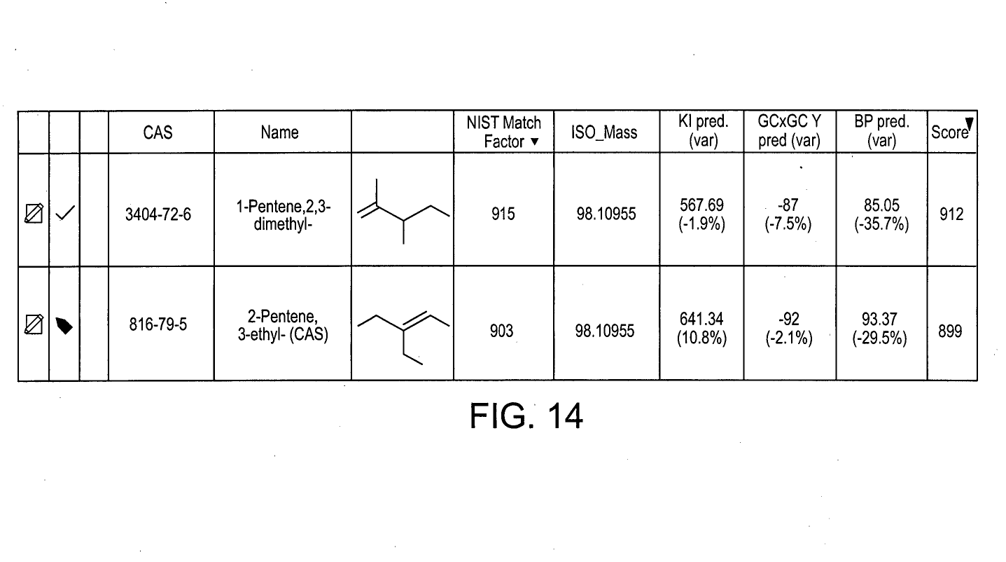

FIGS. 13 and 14 illustrate outputs of the web interface 1000. For a given analysis, all compounds to identify are presented with the structure candidate having the best score (FIG. 13). Structure candidates can be browsed and selection can be changed (FIG. 14). Each structure candidates (Hits) for compound to identify (Query, in this case 1-Pentene, 2,3-dimethyl) are listed with predicted properties. The one with the best score is selected by default. User can change the selection and add comments which will be inserted with the selected structure into a chemical registration system.

The methods of the invention are described in details below by way of two non-limiting examples. The two examples use different numbers of compounds for training, testing, and validation. It should be understood that the coefficients and associated molecular descriptors obtained in the examples below are illustrative of the methods, and depends in part on the data library, experimental setup, the compounds, the number of compounds used in setting up the models.

### Example 1

### Models for Prediction of Analytical Properties

All QSPR models for the development of CASI are built under the same principles. Compounds of known structure are split randomly into a training set (in this example, 90 compounds) and a test set (in this example, 35 compounds). In addition, in this example, 35 different compounds are used as a validation set. Without limitation, 50 to 500 compounds can be used for training. Different distribution of compounds between the sets could be chosen for model establishment. Chemical structures represented in computer-readable format are prepared using software known in the art, in this case, Pipeline Pilot 8.0.1 (Accelrys, Inc. San Diego, Calif., USA). During the preparation. salts are stripped from the compounds' structures using a predefined list, largest fragments are kept, bases are deprotonated and acids are protonated, charges of functional groups are standardized, hydrogens are added, canonical tautomers are generated, and 2D coordinates are generated. Then the duplicate structures are removed.

Molecular descriptors for all the compounds are computed by software known in the art, in this case, Dragon (Talete srl, Milano, Italy). A full description of the molecular descriptors can be found in “Molecular Descriptors for Chemoinformatics” by Roberto Todeschini and Viviana Consonni, WILEY—VCH, 2009 in the Series of Methods and Principles in Medicinal Chemistry—Volume 41 (Eds. R. Mannhold, H. Kubinyi, H. Timmerman). All two-dimensional molecular descriptors (2489 in total for the version of software used in this example) are chosen to be calculated. Descriptors that are correlated to other different descriptors at >=0.97 are redundant and deselected, 321 remaining descriptors are used in the next step.

To construct a predictive model, a set of predictive descriptors is selected in RapidMiner 5 (Rapid-I GmBH, Dortmund, Germany). Other similar data mining software platform known in the art can also be used. Several molecular descriptor selection experiments using forward selection and a genetic algorithm were tried. The performance of forward selection is acceptable, but this method has the inconvenience of a fall in local minima. Stochastic methods like genetic algorithms generally perform better. For this reason, genetic algorithms are used to select molecular descriptors.

The implementation of genetic algorithms in the systems of the invention uses roulette-wheel selection and two point crossover. Each string of molecular descriptors referred to as “chromosome” contains a predefined number of “genes”, and each gene codes for a descriptor. Generally, we select between 2 and 15 descriptors. The genes are not binary, but contain the position of the corresponding descriptor in a list. This allows using a minimum number of descriptors. The fitness function set the subset of descriptors in the “Select Attributes” nodes of the RapidMiner process, executes it, and gets the root mean squared error of the training set as the fitness score. Mutation rate was set to 0.1, the number of chromosomes per generation was set to 20 to 40, preferably 30 and the number of generation was set to 100 to 300, preferably 200. The two best chromosomes survive at each generation.

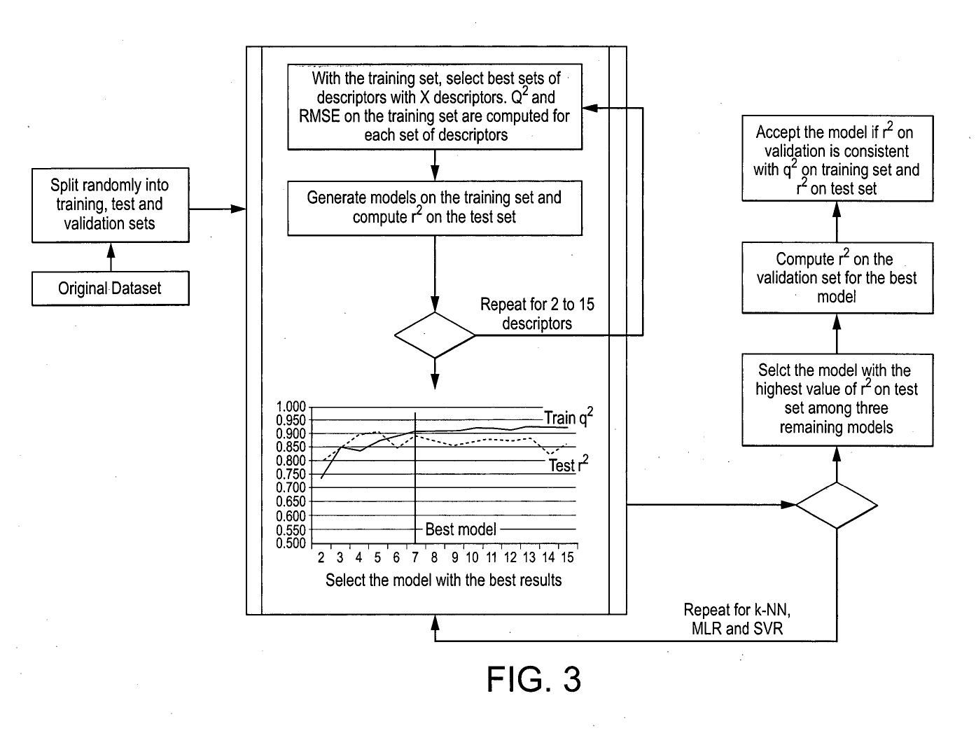

In an exemplary workflow using Rapidminer, data preparation is constituted of a node which selects a subset of attributes, normalization with Z-transformation, separation of data set into training test (75%) and test set (25%). Then a linear regression is applied on the training set, the learned model is applied on both training set and test set. In addition leave-one-out cross validation on training set was carried out. Various different learning algorithms are used to build the models for prediction of KI and relative second dimension retention time. Various learning algorithms were used, such as but not limited to k-Nearest Neighbors (k-NN), Multi Linear Regression (MLR) and Support Vector Regression (SVR). For each learning algorithm, from 2 to 15 descriptors were used to generate the models. At the end of the modeling run, the best model is kept for each value to predict. This process is described in FIG. 3.

### Kovats Indices (KI) Model

In this example of prediction of KI, the genetic algorithm (GA) was combined with three different learning algorithms. To predict the KI of a structure, the k-NN algorithm will compute the distances between the descriptors of the compound for which the KI has to be predicted and the descriptors of each compound of the training set. If k=1 (with k the number of nearest neighbors), the KI of the most similar compound of the training set is chosen as a result of the prediction. If k>1, the mean value of the KI of the k most similar compounds is returned as the predicted value. Generally a weighted mean value based on the distance is used. k=2 was used with weighted contribution and Euclidian distance as a metric.

Multi linear regression is an extension of linear regression with several descriptors:

$$Y = b + {\sum }_{i = 1}^{n} {a}_{i} \times {X}_{i}$$

where Y is the value to predict, b is a constant value, n is the number of descriptors, Xᵢ is a descriptor and aᵢ is a coefficient.

Support vector machine (SVM) is a learning algorithm for classification proposed by V. Vapnik (C. Cortes and V. Vapnik. Support vector networks. Machine Learning, 20:273-297, 1995) and support vector regression (SVR) is an extension of SVM (Harris Drucker, Chris J. C. Burges, Linda Kaufman, Alex Smola and Vladimir Vapnik (1997). “Support Vector Regression Machines”. Advances in Neural Information Processing Systems 9, NIPS 1996, 155-161, MIT Press). SVM defines a hyperplane in a high dimensional descriptor space of the training set which separates two categories of data. Epsilon support vector regression with a linear kernel was used as implemented in libsvm (Chih-Chung Chang and Chih-Jen Lin, LIBSVM: a library for support vector machines. ACM Transactions on Intelligent Systems and Technology, 2:27:1-27:27, 2011). The cost parameter C is optimized at same time as the selection of molecular descriptors. The k-NN, MLR and SVR learning algorithms were used within RapidMiner 5.0 (RapidMiner 5.0, Rapid-I GmbH).

Genetic algorithms (GA) in Java were developed to select descriptors used in models. Each gene in a GA codes for a descriptor to be used in the model, representing an integer with a value between 1 and n (number of descriptors; for instance, 370 in the example below), corresponding to its position within the descriptor list. In the case of SVR, an additional gene containing the value for C parameter is added. Chromosome size is fixed and controlled in a way having no duplicate descriptors in a chromosome. Roulette-wheel selection and two point crossover were used. Mutation rate was set to 0.1, the number of chromosomes per generation was set to 30 and the number of generation was set to 200. In the GA, the two best chromosomes survive at each generation. The scoring function executes a RapidMiner protocol. Cross validation squared correlation (Q²) was used as scoring function for k-NN and MLR and root mean squared error (RMSE) was used for SVR. Chromosome size is fixed between 2 and 15 (plus one for the C parameter in the case of SVR) thus for each kind of learning algorithm (k-NN, MLR and SVR). The genetic algorithms are executed fourteen times. At the first execution the size of chromosomes is fixed to 2. The size of the chromosome is increased at each execution to reach 15 at the last execution. The best solution is kept after each execution. To select the optimal number of descriptors among the fourteen solutions for a given model we chose, for each model to build, the best compromise between r² of the training set and r² of the test set. The r² of the chosen model was calculated on the validation set to ensure robustness.

The results are presented in Table 1:

TABLE 1
Result of the best models for KI with multi linear regression, k-nearest
neighbors and support vector machine regression. Q2 values were
obtained with leave-one-out cross validation for MLR and 10 folds
cross validation for kNN and RMSE value was obtained by 5 folds
cross validation for SVR. Results shown in bold is selected as the
best solution.

| | | | | GA-epsilon SVR |
|---|---|---|---|---|
| | | GA-MLR | GA-kNN | (linear kernel) |
| KI | Q2 | 0.988 | 0.972 | 0.979 C = 1.9 × 10−3 |
| | R2 (test set) | 0.982 | 0.956 | 0.957 |

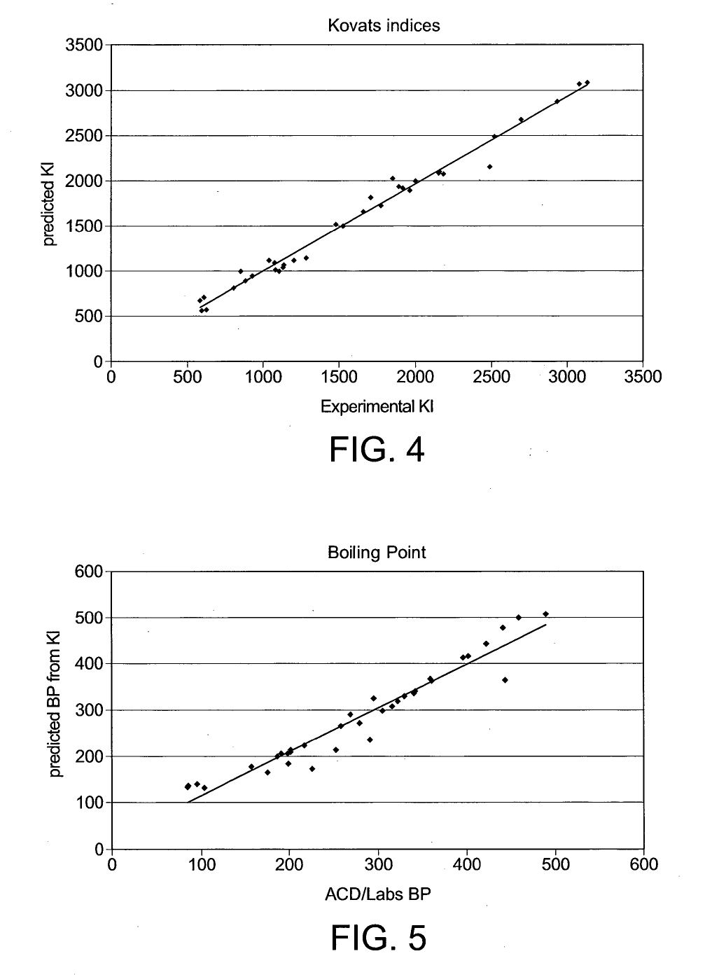

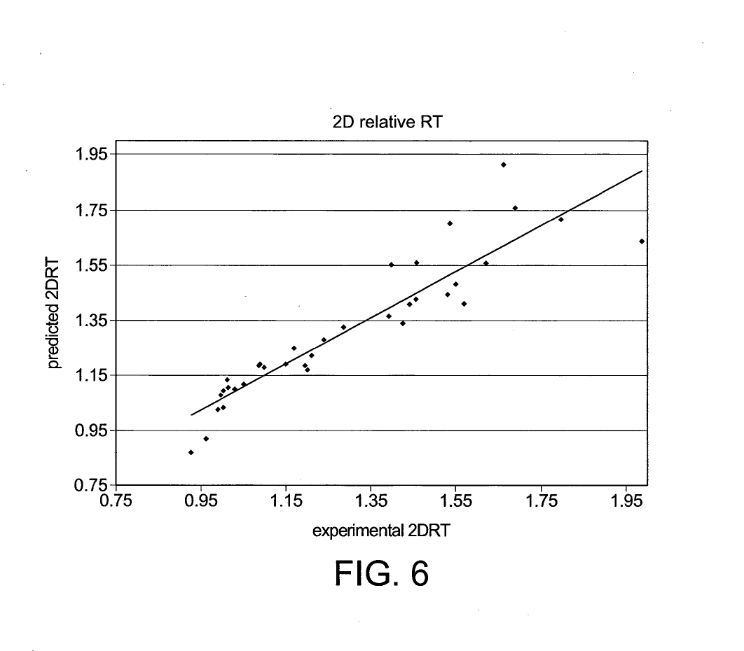

The best results were obtained with a genetic algorithm—linear model using 15 descriptors. Exemplary descriptors are presented in Table 2; these or any other suitable descriptors may be used. Results obtained with this linear model are very good with r² on training set=0.991, q² for leave one out on training set=0.988 and r² test set=0.982. r² on the external test set is also very good (r²=0.985, see FIG. 4).

TABLE 2
Descriptors used in the selected KI model.

| Coefficient | Descriptor | Description |
|---|---|---|
| 236.746 | nSK | Number of non-H atoms. |
| −140.487 | TI1 | First Mohar index TI1. |
| +60.674 | Wap | All-path Wiener index. |
| −57.063 | Jhetm | Balaban-type index from mass weighted distance |
| | | matrix. |
| +54.075 | PW4 | Path/walk 4-Randic shape index. |
| 117.349 | AAC | Mean information index on atomic composition. |
| +67.819 | ATS6v | Broto-Moreau autocorrelation of a topological structure - |
| | | lag 6/weighted by atomic van der Weals volumes. |
| +149.892 | EEig10x | Eigenvalue 10 from edge adj. matrix weighted by edge |
| | | degrees. |
| −101.933 | EEig10d | Eigenvalue 10 from edge adj. matrix weighted by dipole |
| | | moments. |
| +69.663 | BEHe3 | Highest eigenvalue n. 3 of Burden matrix/weighted by |
| | | atomic Sanderson electronegativities. |
| −58.337 | nCrq | Number of ring quaternary C(sp3). |
| −7.834 | C-034 | Fragment R—CR . . . X |
| +49.347 | Hy | Hydrophilic factor. |
| −44.028 | Inflammat-80 | Ghose-Viswanadhan-Wendoloski anti-inflammatory-like |
| | | index at 80%. |
| +283.204 | F02[C—C] | Frequency of C—C at topological distance 2. |
| 1609.956 | b | Constant in multi linear regression equation |

In another example of prediction of KI, a genetic algorithm—a linear model using 12 descriptors is used. Exemplary descriptors are presented in Table 3 below. Results obtained with this linear model yielded with r2 training set=0.992, q2 leave one out=0.999 and r2 test set=0.983.

TABLE 3

| Coefficient | Descriptor | Description |
|---|---|---|
| 2490.980 | nSK | Number of non-H atoms. |
| −3470.745 | nC | Number of C atoms |
| −48.955 | nR06 | Number of 6 membered rings |
| −48.134 | Qindex | Quadratic index |
| −211.303 | DELS | Molecular electropological variation |
| −45.839 | SRW09 | Self-returning walk count of order 9 |
| −63.030 | CIC3 | Complementary information content |
| | | (neighbourhood symmetry of 3-order) |
| +328.644 | ATS1p | Bronto-Moreau autocorrelation of |
| | | topological structure - lag 1/weighted |
| | | by atomic polarizabilities |
| +25.916 | EEig15x | Eigenvalue 15 from edge adj. matrix |
| | | weighted by egde degrees. |
| −31.625 | JGI6 | Mean topological charge index of order 6 |
| −59.809 | B01[C—Si] | Presence/absence of C—Si at topological |
| | | distance 1 |
| +1539.797 | F01[C—C] | Frequency of C—C at topological distance 1 |
| +1561.023 | b | Constant in multi linear regression equation |

### Boiling Point Model

In this example, the correlation between the boiling point (calculated with ACD/Labs ACD/PhysChem) and the boiling point calculated from Kovats Indices values are: r² training set=0.955, r² test set=0.910 and r² validation set=0.934 (FIG. 5). The equation obtained is:

BP=0.1468×KI+47.402

In another example, the correlation between the boiling point (calculated with ACD/Labs ACD/PhysChem) and the boiling point calculated from Kovats Indices values are: r2 training set=0.902, q2 leave one out=0.899, r2 test set=0.891 and r2 validation set=0.934 (FIG. 3). The equation obtained is:

BP=0.1464×KI+47.2755

### Relative Second Dimension Retention Time Model

For the relative second dimension time of the GC×GC-MS, genetic algorithms with three different learning algorithms as described above were used. The results are presented in Table 4:

TABLE 4
Result of the best models for 2DRT with multi linear regression,
k-nearest neighbors and support vector machine regression. Q2
values were obtained with leave-one-out cross validation for MLR
and 10 folds cross validation for kNN and RMSE value was
obtained by 5 folds cross validation for SVR. Results shown in
bold are selected as the best solution.

| | | | | GA-epsilon SVR |
|---|---|---|---|---|
| | | GA-MLR | GA-kNN | (linear kernel) |
| 2DrelRT | Q2 | 0.861 | 0.841 | 0.840 C = 3.8 |
| | R2 (test set) | 0.750 | 0.673 | 0.827 |

One of the best model was obtained by using genetic algorithms and support vector regression analysis. The results obtained are q² leave one out=0.840, r² test set=0.827 and r² validation set=0.849. The model is less accurate than the KI model. It can be explained by the fact that the variances of experimental measured second dimension retention times (respectively 2D relative RT) is higher than for the KI and in addition the relation between the structures and the retention times is not linear. However with a r²=0.849 for the external test set, the model has a good accuracy. In this example, the model uses 8 descriptors as presented in Table 5.

TABLE 5
Descriptors used for the 2D rel RT model.

| Descriptor | Description |
|---|---|
| Wap | All-path Wiener index. |
| AMW | Average molecular weight. |
| X0Av | Average valence connectivity index chi-0. |
| nRCO | Number of ketones (aliphatic). |
| ZM2V | Second Zagreb index by valence vertex degrees. |
| JGI3 | Mean topological charge index of order 3. |
| X0A | Average connectivity index chi-0. |
| piPC10 | Molecular multiple path count of order 10. |

In another example, wherein the second dimension of the GC×GC-MS set up is polar, one of the best model was obtained by using genetic algorithms and 2 nearest neighbors analysis. The results yielded q2 leave one out=0.899, r2 test set=0.816 and r2 validation set=0.811. The model is less accurate than the KI model. It can be explained by the fact that the reproducibility of experimental measures is lower, and that relation between the structures and the retention times is not linear. However with a value of r2=0.811 for the external test set, the model has a good accuracy. In this particular example, the model uses 14 descriptors as presented in Table 6.

TABLE 6
Descriptors used in the GCxGC-TOF second column relative
retention time model

| Descriptors | Description |
|---|---|
| AMW | Average molecular weight. |
| MSD | Mean square distance index (Balaban). |
| BLI | Kier benzene-likeness index. |
| PW5 | Path/walk 5 - Randic shape index. |
| ICR | Radial centric information index. |
| piPC04 | Molecular multiple path count of order 4. |
| X0Av | Average valence connectivity index chi-0. |
| AAC | Mean information index on atomic composition. |
| ATS5m | Broto-Moreau autocorrelation of a topological |
| | structure - lag 5/weighted by atomic masses. |
| GATS2v | Geary autocorrelation - lag 2/weighted by atomic van der |
| | Waals volumes. |
| BEHe1 | Highest eigenvalue n. 1 of Burden matrix/weighted by |
| | atomic Sanderson electronegativities |
| F06[Si—Si] | Frequency of Si—Si at topological distance 6. |
| F09[C—O] | Frequency of C—O at topological distance 9. |
| F10[C—Si] | Frequency of C—Si at topological distance 10. |

### Calculation of a Match Score

Scores for each of the candidate compounds are calculated from the spectral similarity value of each candidate compound given an analyte, (in this example, the NIST MS Search match factor), predicted KI, predicted second dimension relative retention time of the GC×GC-TOF and the predicted boiling point, using a hyperbolic equation. The general principle is based on similarity of experimental MS to library MS multiplied by analytical property scores derived from each analytical property (KI, BP . . . ). The analytical property scores (KIFIT, BPFIT . . . ) are normalized from 0 (no similarity) to 1 (perfect match). The scores are based on quadratic equation via polynomials factorization of the type:

ax²+bx+c=a(x−α)(x−β)

Using KI as an example of one of the analytical properties the terms of the equation are:

$$a = \frac{1}{\begin{matrix}- ( {KI}_{Exp} - ( {KI}_{Exp} - ( {n}_{KI} \times {SEP}_{KI} ) ) ) \times \\ ( {KI}_{Exp} - ( {KI}_{Exp} + ( {n}_{KI} \times {SEP}_{KI} ) ) )\end{matrix}}$$

$$( x - α ) = ( {KI}_{Pre} - ( {KI}_{Exp} - ( {n}_{KI} \times {SEP}_{KI} ) ) )$$

$$( x - β ) = ( {KI}_{Pre} - ( {KI}_{Exp} + ( {n}_{KI} \times {SEP}_{n} ) ) )$$

The complete equation is:

$${hyp}_{KI} = \frac{1}{\begin{matrix}- ( {KI}_{Exp} - ( {KI}_{Exp} - ( {n}_{KI} \times {SEP}_{KI} ) ) ) \times \\ ( {KI}_{Exp} - ( {KI}_{Exp} + ( {n}_{KI} \times {SEP}_{KI} ) ) )\end{matrix}} \times ( {KI}_{Pr e} - ( {K}_{Exp} - ( {n}_{KI} \times {SEP}_{KI} ) ) ) \times ( {KI}_{Pr e} - ( {KI}_{Exp} + ( {n}_{KI} \times {SEP}_{KI} ) ) )$$

[if hyp_{KI}<0 then y=0]

With:

hyp_{KI}: hyperbolic equation which is used to correct the value of NIST Match Factor in the CASI score.

KI_{Pre}: predicted Kovats Index

KI_{Exp}: measured Kovats Index

n_{KI}: factor (for curve fitting)=e.g. n for Kovats Index

SEP_{KI}: standard error of prediction

Curve Analysis:
Maximum: if KI_{Pre}=KI_{Exp}, y=1
Zero-crossing1: KI_{Pre}=KI_{Exp}−n_{KI}×SEP_{KI}
Zero-crossing2: KI_{Pre}=KI_{Exp}+n_{KI}×SEP_{KI}

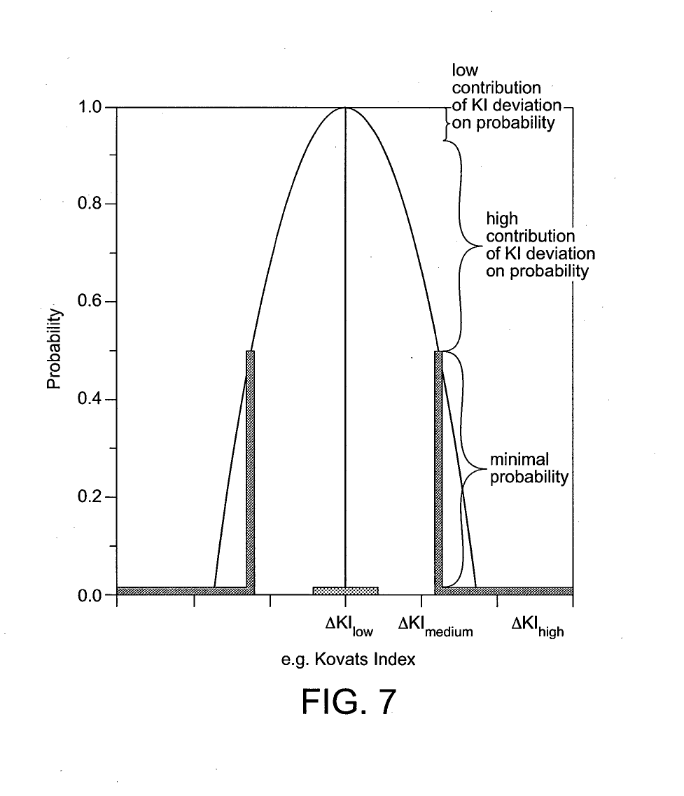

A graphical interpretation of the derived hyperbolic equation is shown in FIG. 7. The higher the deviation between experimental and predicted values, for example, KI, the lower the probability of the proposal depending on the curve fitting function used. The higher the steepness of the curve, the higher the contribution of a parameter's deviation on the probability of the fitting function, the higher their contribution on the overall CASI score.

An exemplary formula for combining the three analytical property scores and the spectral similarity value to calculate a match score, is as follows:

CASI Score=NIST MF×hyp_{KI}×hyp_{2DRT}×hyp_{BP}

For each analyte in a query, the candidate compounds are ranked according to decreasing CASI scores. CASI score is calculated according to the above-described equation. The hit with the highest value is selected by default.

Score Optimization

In calculating the CASI score, each of the three analytical property scores has four parameters. However, only n_{X} has to be established which defines at which value the hyperbolic curve crosses the X axis. n_{X} is contributing to the shape of the hyperbolic curve, and then to the weight of each analytical property score in the final CASI score.

A grid search procedure is provided to establish optimal values for n_{KI}, n_{2DreIRT} and n_{BP}. A solution's score is generated by using every possible combination of integer values between 1 and 50 for each of n_{KI}, n_{2DreIRT} and n_{BP}. In consequence the range for optimization of the contribution function is covering from difference of predicted to measured parameter multiplied by 1 to 50-fold standard error of prediction for crossing the x-axis. The solution's score is the number of correct hits sorted first for training set and test set. The solution with the highest number of correct hits is selected. The algorithm can be described as follow:
for n_{KI} in 1 . . . 50
   for n_{2DRT} in 1 . . . 50
      for n_{BP} in 1 . . . 50
         compute CASI score for the compounds in the training sets and in the test sets using combinations of values of n_{KI}, n_{2DRT} and n_{BP} for each iteration.
         count the number of correct hits for this iteration.
select the values of the solution with the greatest number of correct hits.

The selected n_{KI}, n_{2DreIRT} and n_{BP} parameters will be used in the final validation step of the configuration in CASI.

### Validation of the CASI Scores

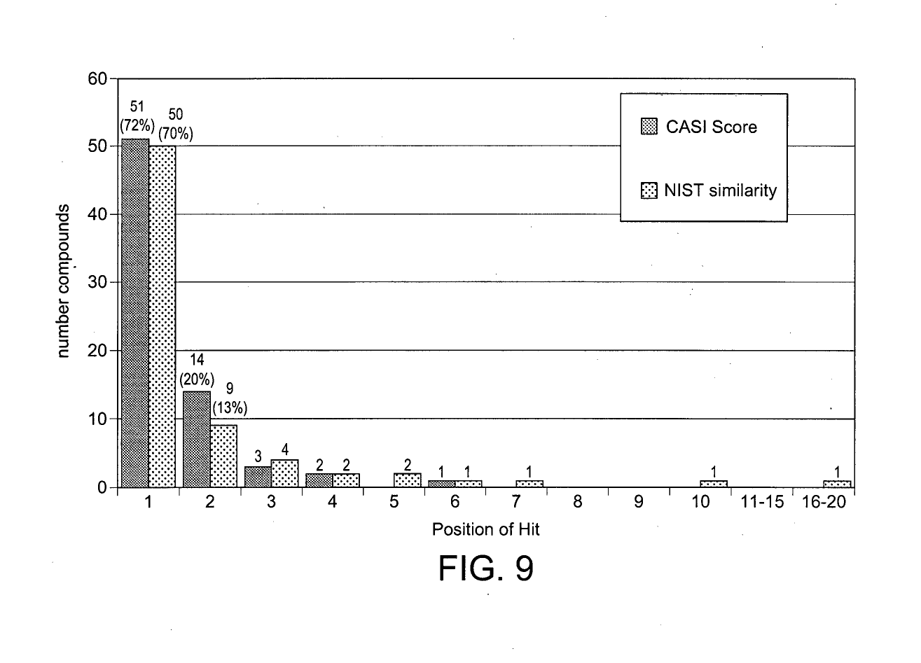

To validate the performance of the methods of the invention, a set of 71 molecules whose identities are known are used. Results are shown in FIG. 9. Some of these molecules are present in the validation set used to validate the models, but none of them are present in the training set and test set. The results obtained by using the CASI system are clearly better than using the NIST match factor alone: 51 correct hits ranked first and 14 correct hits ranked in second position. Using NIST Match Factor, 50 correct hits ranked first but only 9 correct hits sorted in second position. The ranking of correct structures with CASI Score is compared to the ranking using NIST Match Factor in the Table 7:

TABLE 7
Comparison of the position of correct hits by ranking
based on CASI score and ranking based on NIST Match
Factor. CASI score performs better than NIST Match
Factor in term of ranking of correct hits.

| Position of correct hits | 1 | 2 | 3 | 4 | 5 | 6 | 7 | 10 | 20 |
|---|---|---|---|---|---|---|---|---|---|
| Frequency with CASI | 51 | 14 | 3 | 2 | | 1 | | | |
| score | | | | | | | | | |
| Frequency NIST Match | 50 | 9 | 4 | 2 | 2 | 1 | 1 | 1 | 1 |
| Factor | | | | | | | | | |

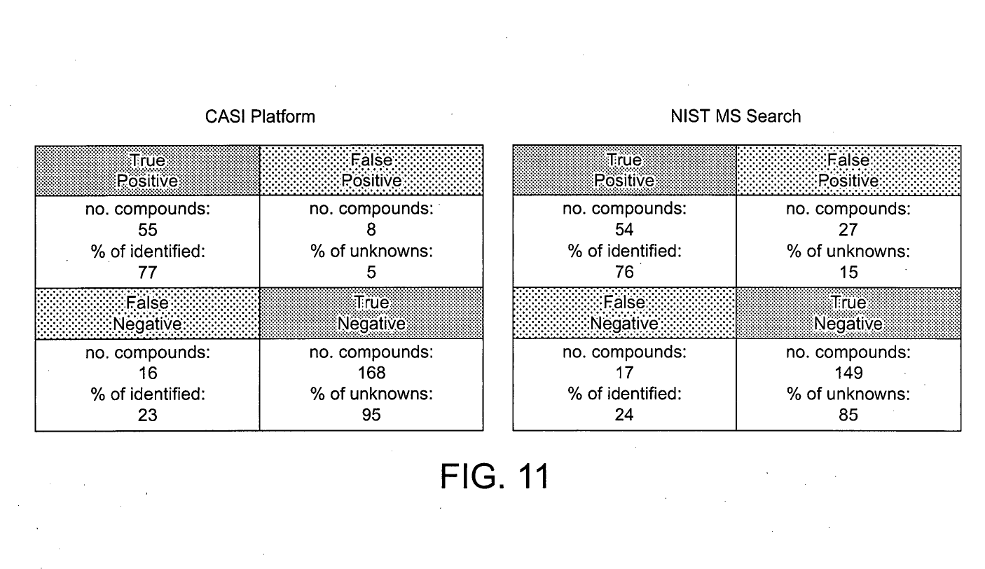

By analyzing the true/false positives and true/false negatives rate shown in contingency table (FIG. 11), the rate of false positive structural assignments is reduced significantly for the CASI score compared to the NIST MS search. Accordingly, CASI score each 9^{th} structural assignment is a wrong assignment, whereas for the NIST MS search each 3^{rd} structural assignment is a false one.

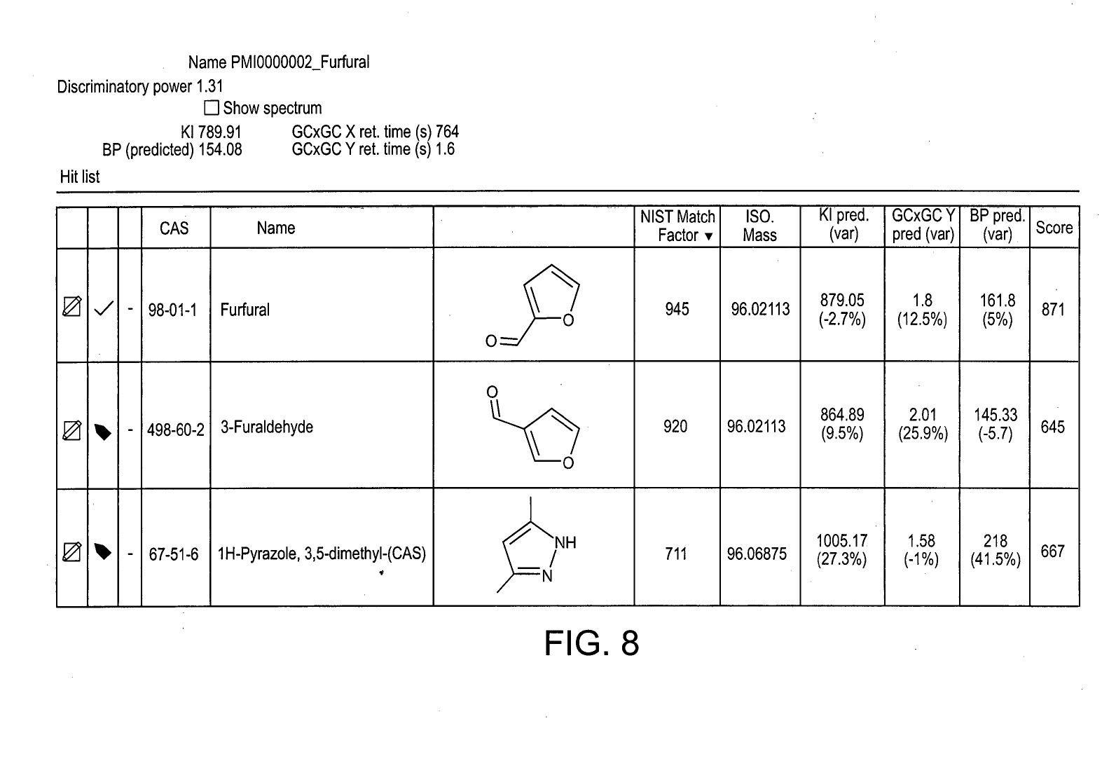

An illustrative example of the advantage of the CASI score is the hentriacontane, which is sorted in 20th position with NIST MF but sorted in 2nd position with CASI score, because of the accurate prediction of the KI. Another example presented in FIG. 8 is Furfural which shows clearly that CASI score gives a better discriminatory power than NIST Match Factor. CASI score as well as NIST Match Factor rank the correct hit in first position, but CASI Score gives a much higher discriminatory power.

These results clearly show that the CASI system improves the confidence and increase the throughput in structure identification.

The results obtained from the CASI system can be confirmed by the use of GC-APCI-TOF-MS. A sample comprising analytes are combined with deuterated n-alkanes and deuterated fatty acids methyl esters, divided into two aliquots. One was analyzed by GC×GC-TOF-MS wherein the Kovats index of the FAMEs and analytes are determined using deuterated n-alkanes as the reference system. The other aliquot is analyzed in a GC-APCI-MS wherein the absolute retention time of the FAMEs are determined. By applying the above-described methods for bridging the retention index systems, the deviation of Kovats Index was found to be less than 1% between both systems and the mass deviation was found to be less than 1 mDa for the GC-APCI-TOF-MS.

The ability to confirm proposed structures using accurate masses measured by GC-APCI-TOF-MS was tested. The method is used to confirm the proposed structures of 155 compounds present in cigarette smoke. 120 of the 155 compounds are ionizable in the GC-APCI-TOF-MS. 106 compounds are detected within the retention time index window and 85 compounds are confirmed automatically.

### Example 2

### Instrumentation and Analytical Methods

### Data Generation

The experiments were performed using the LECO GC×GC-TOF system Pegasus IV. Cigarette smoke, collected on glass-fiber filter pads was extracted with an organic solvent and fortified with a mixture of several deuterated internal standard and retention time marker compounds. The cigarette smoke extracts were analyzed directly after liquid-liquid partitioning with dichloromethane/water as well as derivatized raw extract using BSTFA/TMCS by injecting the extracts in cool-on-column mode onto the analytical system. The separation of the complex mixture was performed in the two-dimensional mode using a nonpolar/polar analytical column combination for the first/second dimension chromatography. Helium as carrier gas was kept to a constant flow of 1.0 ml/min. A 30 m DB-5 ms analytical column with an internal diameter of 0.25 mm and film thickness of 0.25 μm was used for the first dimension and a 2.2 m DB-17ht with an internal diameter of 0.10 mm and film thickness of 0.1 μm for the second dimension. A linear temperature gradient was used starting from 30° C. (2 min) with 5°/min to 320° C. (15 min) for the first dimension and 35° C. (2 min) with 5.2°/min to 340° C. (14.5 min). The second dimension separation time was 6 sec/modulation and the data acquisition rate was set to 200 spectra/sec.

### Data Processing

Data processing was performed in a non-targeted screening setup using ChromaTOF software for automatic peak finding, spectral deconvolution, and peak alignment, resulting in an aligned peak table. The data were evaluated with a focus on the most relevant differences in chemical composition. This was done by application of student's t-test to filter compounds with significant difference followed by a ranking procedure considering the relative differences in abundance as well as the (semi-)quantitatively determined absolute abundances.

The software is accessible to a user through a web interface. The user enters all mass spectra to be analyzed in a multi JDX file, retention values for a single or for two retention columns and some additional information to describe the experiment. Then the following analysis is processed automatically, each query mass spectrum is searched against commercial mass spectra databases using NIST MS Search (NIST MS Search Program v2.0f, National Institute of Standards and Technology). A list of name of potential hits is then generated and a match factor, representing the similarity between the query mass spectrum and the hit mass spectrum, is given for each hit. Chemical names of the hits are then converted to chemical structures. For each hit, three predictive models are applied to calculate the predict Kovats indices, boiling points and relative retention times for the second column. These three predicted values are combined with the match factor from NIST MS Search as described before to give a CASI Score. For each query the hits are ordered by decreasing CASI scores. The user is shown the results of the analysis through a dedicated web interface. For each query, the structure of the hit with the highest CASI score is selected by default. However, the user can select another hit as the correct structure for the query. In case no candidate compounds matches, the user can choose to not select any structure for the query. At the end of the analysis, optionally after confirmation with reference standards, the user can choose to transfer automatically all the correct structures associated to the query mass spectra to a chemical registration system.

The central component of a software platform that controls the automation of all the process is the core engine and it mainly corresponds to the business layer. The functionalities of the core engine are to execute an analysis and to move the results of an analysis from the CASI database, where all previous CASI analysis are stored, to a chemical registration system. The core engine was developed in Java 6 and it is executed in Tomcat 6.0 (Apache Tomcat 6.0, The Apache Software Foundation). The business layer of the application uses NIST MS Search 2.0f command line tool to search in commercial mass spectral databases. Pipeline Pilot 8.0 process is called with the Pipeline Pilot Java API. The process generates the structures from chemical names of the proposals using chemical names and CAS numbers from a chemical registration system, ACD/Name-to-structure v12 (ACD/Name-to-Structure Batch v. 12, ACD/Labs) software and a ChemSpider web service (ChemSpider, Royal Society of Chemistry). Chemical structures are then standardized: salts are removed, the protonation states are adjusted to a standard form and the canonical tautomer is generated. At the end of the process boiling points are computed using ACD/PhysChem batch v12. Chemical descriptors are computed using Dragon which is integrated by command line. Predictive models are built using RapidMiner 5.0. This software has the advantage to integrate many learning algorithms as well as a workflow based graphical interface.

In addition to these external tools, the standard Java APIs Log 4J was used for logging error messages, Hibernate for the mapping of the objects to the Oracle database and JUnit for the unit tests. Oracle 11gr2 (Oracle Database 11g Release 2, Oracle) was used to store the analysis data. Oracle Application Express (Oracle Application Express 3.2, Oracle) was used for the development of the web interface. It is integrated by default in Oracle 11gr2 and it allows the building of web interface in an efficient way.

### Data Sets

The datasets used for the development of this example of the CASI system are generated based on the results of non-targeted comparisons of different cigarette smoke samples. The non-targeted comparisons using GC×GC-TOF provide a comprehensive picture regarding the chemical composition of samples and differences in chemical composition. The most relevant differences were evaluated by considering the relative differences in abundance as well as the (semi-)quantitatively-determined absolute abundances. The non-targeted screening approaches used in this example consists of two analytical methods, one for non polar compounds and the second for derivatives of polar compounds after trimethylsilylation in order to cover a wide polarity range. The obtained results comprise chromatographic peaks with their associated EI-mass spectra, representing the most relevant differences between the compared samples. The end results provide structural proposals as well as molecules with no available structural proposal, referred to as “unknowns”. In total, using this system, 218 structures were confirmed by reference compounds while the chromatographic as well as mass spectrometric data of 176 unknown compounds were added to the dataset.

The performance of the experimental model for the 2D relative RT was tested by evaluating the reproducibility of the absolute versus relative retention times of the merged datasets of three independent non-targeted screening studies on the comparison of different smoke samples. The focus of this evaluation was made using smoke samples of a reference cigarette as a quality standard and that was analyzed in triplicates, distributed homogenously within each measurement series of each study (N=9). The evaluation was performed using all found peaks in a non-targeted way, having a signal-to-noise ratio exceeding 250. The number of evaluated compounds, regardless if its structure was putatively identified or not, was 1219 compounds in total, and no outlier correction was done.

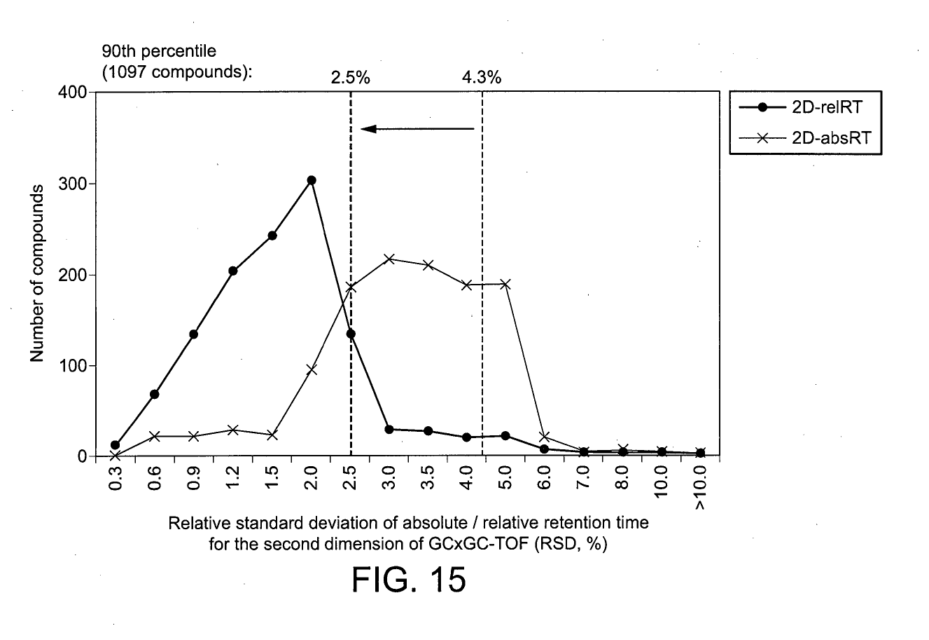

The evaluation of the datasets showed an increase in reproducibility for the relative RT model compared to the traditional absolute RT data, see FIG. 15.

The relative standard deviation for the 90^{th} percentile of all evaluated compounds of the whole dataset was enhanced from 4.3% for the 2D absolute RT data to 2.5% by using the 2D relative RT system.

Prediction of Kovats Indices from Boiling Points

In the present example, the linear equation obtained by the correlation of the computed boiling points and experimental Kovats Indices of the compounds of the training set is:

BP=0.1549×KI+31.725

with a squared correlation of 0.953 (0.938 at 0 intercept). For the compounds of the test set, the squared correlation between the boiling points obtained with this equation and the boiling points computed by ACD/Labs PhysChem is 0.867 (0.867 at 0 intercept). For the compounds of the validation set the squared correlation is 0.942 (0.940 at 0 intercept).

TABLE 8
Result of the best models for KI with multi linear regression and
k-nearest neighbors. Q² values were obtained with
leave-one-out cross validation for MLR and 10 folds cross
validation for kNN. Results shown in bold corresponds to the
selected best solution.

| | MLR | kNN |
|---|---|---|
| Number of descriptors | 7 | 15 |
| r²_{training set} | 0.986 | — |
| q² | 0.984 | 0.979 |
| r²_{test set} | 0.968 | 0.952 |
| r²_{validation set} | 0.981 | 0.933 |
| RMSE_{validation set} | 97 | 184 |
| relative error_{validation set} | 5.18% | 8.92% |

### Predictive Models Results

The predictive models for Kovats Indices were generated using genetic algorithms in combination with MLR and kNN. Best results were obtained with MLR. With seven descriptors the squared correlation r² is 0.981 and the relative error is 5.18% on the validation set, as presented in Table 8. The squared correlation at 0 intercept has a value of 0.980 which is very consistent with the classical squared correlation (the results are similar to those shown in FIG. 4). The contribution of the descriptors and their definition are presented in Table 9.

TABLE 9
List of descriptors and their contribution to the selected linear model.

| Coefficient | Descriptor | Description |
|---|---|---|
| 81.541 | nN | Number of nitrogen atoms. |
| +67.184 | EEig04d | An edge adjancy matrix corresponding to |
| | | Eigenvalue 04 from edje adj. matrix |
| | | weighted by dipole moments. |
| −79.814 | nCt | Number of total tertiary C(sp3). |
| +81.419 | H-047 | An atom centered fragment corresponding |
| | | to H attached to C (sp3)/C(sp2). |
| +110.504 | TPSA(NO) | Topological polar surface area using N, |
| | | O polar contributions. |
| +45.443 | B01[C—O] | A 2D binary fingerprint bit coding for the |
| | | presence of C—O bond at topological |
| | | distance 1. |
| +666.420 | F01[C—C] | A 2D frequency component coding for the |
| | | frequency of C—C bonds at topological |
| | | distance 1. |
| +1557.651 | | Correcting factor. |

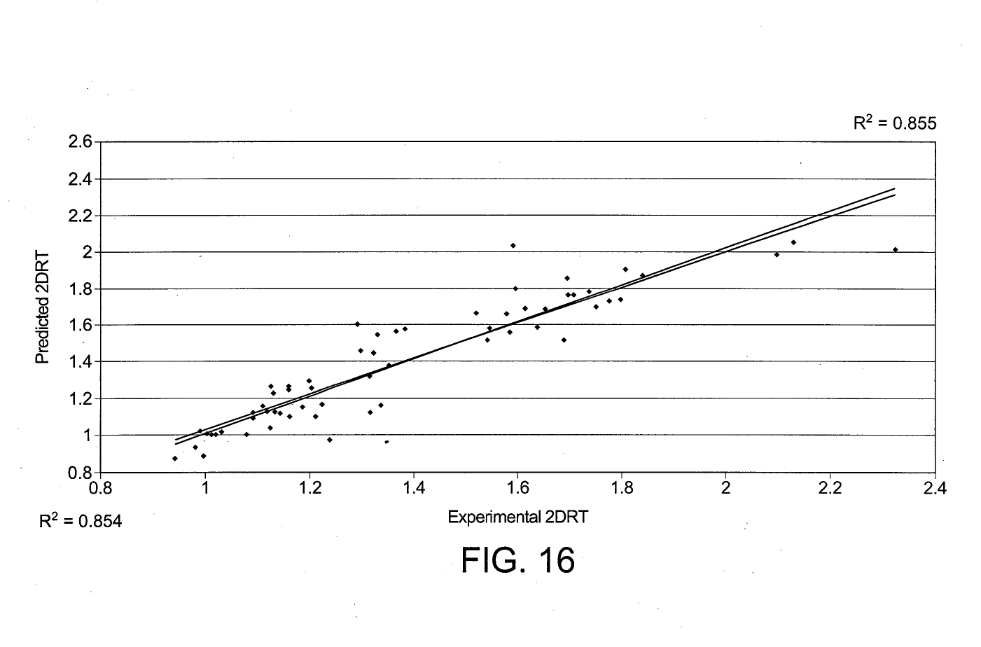

For the 2D relative RT best results were obtained using support vector machine using 12 descriptors (see Table 10). Squared correlation on validation set is 0.855 and the relative error is 6.76%. Squared correlation at 0 intercept is 0.854 which is very similar to the classical squared correlation (FIG. 16). Even if it not as accurate as the KI model, the predictive power of this model is good due to the correction by relative values of the second retention time.

Even using the enhanced 2D relative RT data the predictive model is not as accurate as the KI model, as it was expected due to the fact that the second dimension separation comprises variances on both separations, the first dimension as well as the second dimension separation. In fact these variances are dependant variables, as a retention time shift in the first dimension causes a subsequent shift for the second dimension separation.

TABLE 10
Result of the best models for 2D relative RT with multi linear
regression, k-nearest neighbors and support vector machine
regression. Q² values were obtained with leave-one-out
cross validation for MLR and 10 folds cross validation for kNN
and RMSE value was obtained by 5 folds cross validation for SVR.

| | | | Epsilon SVR |
|---|---|---|---|
| | MLR | kNN | (linear kernel) |
| Number of descriptors | 13 | 14 | 12 |
| r²_{training set} | 0.947 | | 0.936 |
| q²_{training set} | 0.929 | 0.938 | 0.922 |
| r²_{test set} | 0.883 | 0.934 | 0.891 |
| r²_{validation set} | 0.837 | 0.765 | 0.855 |
| RMSE_{validation set} | 0.150 | 0.158 | 0.128 |
| relative error_{validation set} | 7.53% | 6.88% | 6.76% |

### Validation of the CASI System Against the NIST System

The ability of CASI to correctly rank true hits was investigated. The optimization of the score function was performed on the training set and the test set as described before using a grid table for all possible solutions. The standard error of prediction (STEYX function of Microsoft Excel) for the three parameters were computed on all compounds of both training and test sets. Obtained values were SEP_{KI}=82.57, SEP_{2DRT}=0.0771 and SEP_{BP}=23.05. More than 50 000 solutions were generated. Only solutions with the highest number of correct hits for the test set were kept. The best result for the test set was 35 hits sorted correctly on a total of 40 queries (88%) and 93 solutions were obtained. The selected solutions were filtered a second time to keep only those with the highest number of correct hits for the training set. The best score on the training set was 94 compounds identified correctly for 118 (80%). Eleven solutions remained. For all these solutions zero_{KI} was 11 and zero_{2DRT} was 10. The zero_{BP} was different with values equal to 36 and above. The solution with the lowest value for zero_{BP} (=36) was chosen to maintain the highest selectivity for this parameter. The CASI scores were computed for the good hits of all eleven solutions. The value were the same for all the solution with 52 compounds correctly identified on the 60 of the validation set (87%).

If NIST MS Search match factor (MF) only was used, without CASI score, the number of correct hits for the validation set ranked first would have been 45 (75%). Overall CASI score gives better results than NIST MF, with a higher number of correct hits sorted first and less hits with lower ranks. It shows that prediction of retention times for both dimensions of GC×GC and correlation with KI and predicted BP enhanced the results of mass spectra similarity for our validation set.

However one compound, iso-bornyl acetate, had a significantly worse rank with CASI score than with NIST MF: it provides the highest NIST MF but it is sorted at the 27^{th} position with the CASI score, indicating clearly an outlier compound in our ranking. As the NIST MF is the highest for this compound, it is obvious that the predicted retention times and BP are responsible for the bad ranking. This could be confirmed by the analysis of errors of prediction (19.3% for KI and 24.3% for 2D relative RT). As the global correlations were good for the models, the most probable hypothesis to explain these errors is that iso-bornyl acetate is outside the applicability domain of the models. By analyzing the similarity of each compound of the validation set with each compound of the training set, it became obvious that the compound iso-bornyl acetate was the compound of the validation set with the lowest similarity from any compound of the training set. For the evaluation of structural similarity we used Pipeline Pilot 8, Extended Connectivity Fingerprints 6 (ECFP6; see Basic Chemistry Guide of Chemistry collection of Pipeline Pilot) and Tanimoto metric. The most similar compound of iso-bornyl acetate has the low similarity of 0.14 (2,3-butadione). It confirms that the compound iso-bornyl acetate is very dissimilar from the compounds of the training set and consequently very difficult to predict.

Additionally, the contribution of each of the modules KI, 2D rel RT and BP on the outcome of the score were evaluated. For each evaluation only parameters of the considered module were optimized. The results are presented in Table 11.

TABLE 11
Number of correct hits with different combination of CASI scores
components. Results with all the components are presented
in the first line.

| | Number of Correct Hits | | |
|---|---|---|---|
| | Training Set | Test Set | Validation Set |
| NIST MF, KI, 2DRT, BP | 94 | 35 | 52 |
| NIST MF | 87 | 30 | 45 |
| NISTMF, 2DRT | 90 | 31 | 45 |
| NISTMF, KI | 92 | 33 | 48 |
| NISTMF, BP | 92 | 32 | 47 |
| NISTMF, KI, BP | 93 | 33 | 48 |
| NISTMF, KI, 2DRT | 93 | 35 | 52 |
| NISTMF, 2DRT, BP | 92 | 33 | 47 |

Best results were obtained using all three modules KI, 2D rel RT and BP on all kind of evaluated data sets. In order to mitigate the possibility of loosing important information it was not possible to clearly exclude one module from the global approach, as different compounds could be ranked correctly using the different combinations.

In addition, the ability of CASI to discriminate true hits from Unknowns was investigated. Ranking by itself is not sufficient to identify correct structures. In the case that the correct structure is not present in the reference spectra database, the structure proposed by CASI may be wrong. However a wrong structural proposal should have a low score which should help the user on the decision on a structural proposal most probably being right or wrong. A normal usage of CASI will thus combine a score threshold with ranking. In order to study the ability to discriminate between correct and not correct structure proposal we compared the CASI score (Figure) and NIST MF (Figure) profiles of the correct hits of the validation set with the scores of the hit ranked first for a set of 176 unknown compounds (i.e. it was not possible to find a correct structure for these compounds even with a non automated analysis). The hits ranked first for the unknowns are all corresponding to incorrect structures. We see a clear separation between correct hits and unknowns for both scores with a small overlap of the curves.

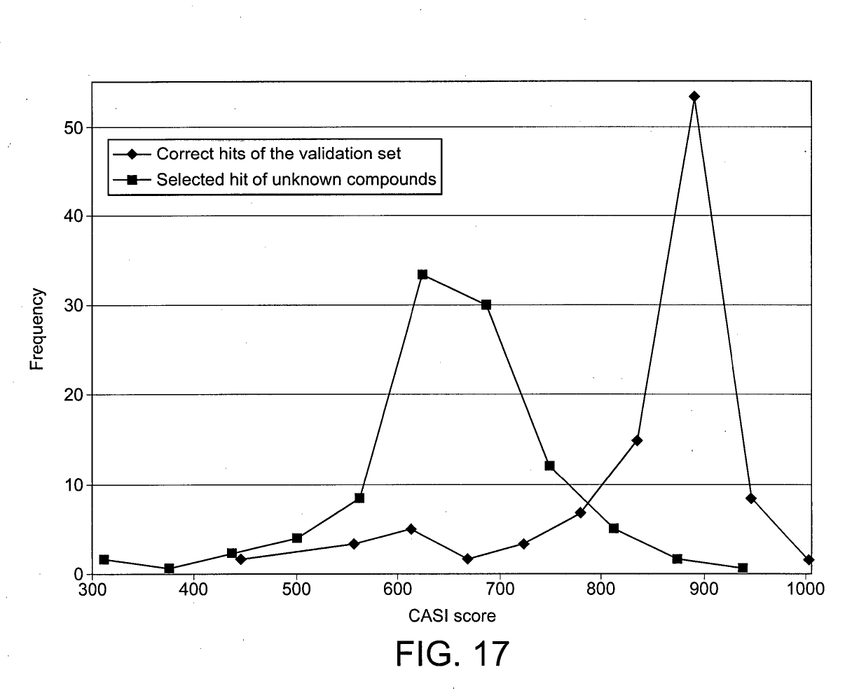

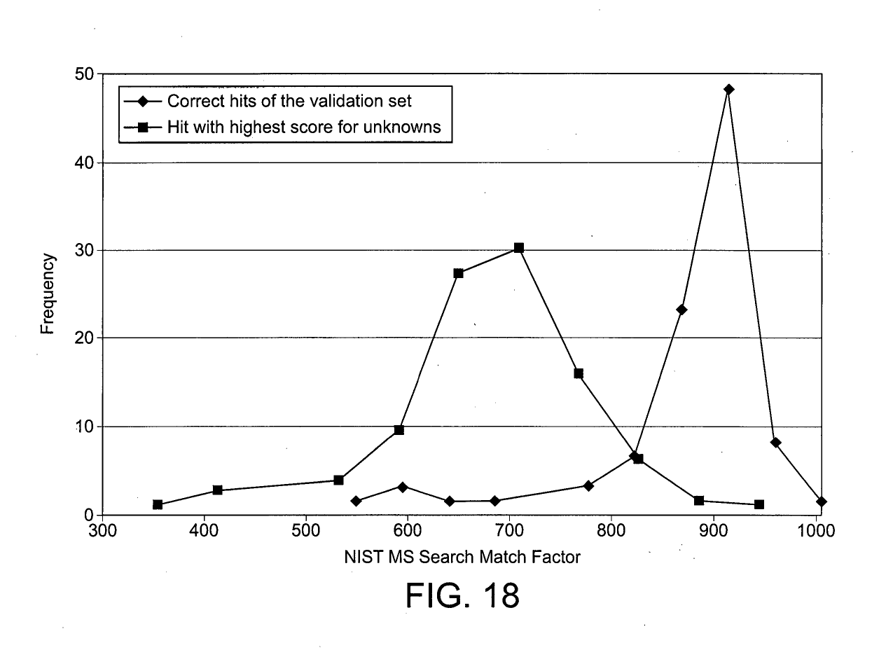

The performance of the CASI platform compared to the NIST MF to discriminate between correct identifications and unknown compounds was evaluated using ranking and score threshold at the same time. We used the validation set and the unknown set for the evaluation which leads to a total of 236 compounds respectively mass-spectra with their associated chromatographic values. We chose a threshold of 795 for the CASI score and of 825 for NIST which corresponds to the score values at which the curves meet (score value with equal probability for correct or not correct proposal), see FIG. 17 and FIG. 18. The results are presented in Table 12. CASI score results in 46 correct hits (77%) for the 60 compounds of the validation set, whereas NIST MF generated 40 correct hits (67%). The ability to discriminate wrong from false hits is more significant if we consider the results on wrong structural proposals exceeding the predefined threshold, thus being suggested to be true identifications (i.e. first hits for unknown compounds with a score above the threshold). By using the CASI score, 11 false positive (19%) among the 57 proposals exceeding the threshold could be found, whereas 29 false positive (42%) among the 69 suggested true identifications could be found with NIST MF.

TABLE 12
Performances of CASI and NIST for structure identification were
assessed using the hits ranked in first position (using NIST MF and
CASI score) of the validation set of 60 spectra and a set containing
176 unidentified compounds (i.e. unknowns). True positives are
correct hits from the validation set ranked first and having a score
above or equal to a predefined threshold (795 for CASI score and
825 for NIST MF). False positives are hits from the unknown set
having a score above the predefined threshold. True negatives
correspond to hits from the unknown set having a score below the
threshold. False negatives are correct hits from the validation set
with a score below the threshold and hits from validation set which
are not corresponding to the correct structure.

| | true | false | true | false |
|---|---|---|---|---|
| | (CASI score) | (CASI score) | (NIST MF) | (NIST MF) |
| positive | 46 | 11 | 40 | 29 |
| negative | 165 | 14 | 147 | 20 |
| total (%) | 89% | 11% | 79% | 21% |

| | |
|---|---|
| cutoff CASI score ≧795 | cutoff MF ≧825 |

1. A method for analysing mass spectral data obtained from a sample in GC×GC (2-dimensional) mass spectrometry, comprising:
(a) comparing mass spectral data of an analyte with mass spectral data of candidate compounds of known structure in a library;
(b) identifying a plurality of candidate compounds from the library based on similarities of mass spectral data;
(c) predicting, for each candidate compound, a value of at least one analytical property using a quantitative model based on a plurality of molecular descriptors; and
(d) calculating a match score for each candidate compound based on the value predicted in step (c) and a measured value of the analytical property for the analyte.

2. The method of claim 1, wherein step (c) comprises predicting, for each candidate compound, values of a plurality of analytical properties, wherein the predicted analytical properties include at least one of a Kovats index, a boiling point and a relative second dimension retention time.

3. The method of claim 1, wherein the relative second dimension retention time of the analyte is a function of the absolute second dimension retention time of the compound and the second dimension retention time of a hypothetical reference standard, wherein the second dimension retention time of a hypothetical reference standard is calculated according to a linear regression on the absolute first dimension retention times and absolute second dimension retention times of a series of reference standard.

4. The method of claim 1, wherein the match score is additionally based on the similarity of mass spectral data in step (b).

5. The method of claim 1, wherein the quantitative model of step (c) is obtained by using a test data set and a genetic algorithm to select the molecular descriptors from a plurality of possible molecular descriptors, and using a machine learning algorithm selected from linear regression, support vector regression, or k nearest neighbours method to correlate the selected molecular descriptors with the value to predict.

6. The method of claim 1, wherein said quantitative model of step (c) is the product of a method for establishing quantitative model, which comprises the following steps:
(i) providing a set of training compounds of known structure and a set of test compounds of known structure, and optionally a set of validation compounds of known structure;
(ii) generating a measured value of an analytic property for each training compound, each test compound, and each validation compound;
(iii) for each training compound, computing a set of molecular descriptors based on chemical structure and properties;
(iv) selecting a set of molecular descriptors from the set of molecular descriptors for use in a quantitative model of the analytical property, by using a genetic algorithm;
(v) generating a plurality of proposed quantitative models using the selected set of molecular descriptors;
(vi) evaluating each proposed quantitative model by computing a predicted value of the analytical property for each test compound
(vii) selecting the quantitative model according to the root mean square error (RMSE) and/or the squared correlation (r²) on the measured value and the predicted value of the analytical property for each test compound; and optionally
(viii) selecting the quantitative model according to the root mean square error (RMSE) and/or the squared correlation (r²) on the measured value and the predicted value of the analytical property for each validation compound.

7. The method of claim 6, wherein using the genetic algorithm of (iii) comprises
(p) generating a plurality of candidate solutions using a combination of two or more molecular descriptors in a machine learning algorithm selected from multiple linear regression, k-nearest neighbour method, or support vector regression;
(r) scoring each candidate solution according to a fitness function based on the cross validation squared correlation (q²) of the training compounds
(s) generating new candidate solutions by recombining and/or mutating the candidate solutions that produces an increased cross validation squared correlation; and
(t) repeating step (r) and (s) for a finite number of times.

8. The method of claim 1, for computing the relative second dimension retention time, the hypothetical reference standard is a hypothetical deuterated n-alkane, and the series of reference standards comprises deuterated n-alkanes.

9. The method of claim 1, further comprising verifying a candidate structure by a method comprising the steps of:
(A) measuring Kovats indices of analytes relative to a first set of reference compounds in GC×GC-TOF-MS;
(B) measuring Kovats indices of a second set of reference compounds relative to the first set of reference compounds in GC×GC-TOF-MS;
(C) measuring absolute retention times of the second set of reference compounds in a GC-APCI-TOF-MS; and
(D) using the Kovats indices of the second set of reference compounds measured in step (b) to derive by linear regression a function for converting the Kovats indices of the analytes measured in step (A) into estimated absolute retention times of the analytes in the GC-APCI-TOF-MS.

10. The method of claim 9, further comprising:
(E) measuring the absolute retention times of the analytes in the GC-APCI-TOF-MS;
(F) using the function calculated in step (D) to convert the absolute retention times measured in step (E) into calculated Kovats indices in the GC-APCI-TOF-MS for the analytes; and
(G) comparing the Kovats indices calculated in step (F) with the measured Kovats indices from step (A).

11. The method of claim 9, wherein the function of step (D) is derived by linear regression for each retention time range where an analyte is detected between two adjacent reference compounds of the second set of reference compounds, wherein the function is:
RT analytes in GC-APCI-TOF-MS=a(KI analytes in GC×GC-TOF-MS)+b,
where a is a coefficient and b is constant for a specific time range.

12. The method of claim 9, further comprising comparing the molecular masses of the analytes with the molecular masses of the respective candidate compounds for each of the analytes.

13. The method of claim 9, wherein the first set of reference compounds deuterated n-alkanes and the second set of reference compounds deuterated fatty acids methyl esters.

14. A method of calculating a predicted relative second dimension retention time in a GC×GC-MS (2-dimensional gas chromatography coupled to mass spectrometry) for a molecular structure comprising the steps of:
(a) defining a reference system based on a function of hypothetical deuterated n-alkanes;
(b) transforming measured values of absolute second dimension retention times for a plurality of training compounds of known molecular structure into the reference system to calculate relative second dimension retention times for the training compounds;
(c) using the relative second dimension retention times for the training compounds to generate a quantitative model of relative second dimension retention time based on a plurality of molecular descriptors;
(d) using the quantitative model to predict a relative second dimension retention time of the molecular structure.

15. A computer system programmed to carry out the method of claim 14, operatively connected to a GC×GC (2-dimensional) mass spectrometer.

16. A computer system programmed to carry out the method of claim 1, operatively connected to a GC×GC (2-dimensional) mass spectrometer.

17. The method of claim 2, wherein the relative second dimension retention time of the analyte is a function of the absolute second dimension retention time of the compound and the second dimension retention time of a hypothetical reference standard, wherein the second dimension retention time of a hypothetical reference standard is calculated according to a linear regression on the absolute first dimension retention times and absolute second dimension retention times of a series of reference standard.

18. The method of claim 17, wherein the match score is additionally based on the similarity of mass spectral data in step (b).

19. The method of claim 2, wherein the match score is additionally based on the similarity of mass spectral data in step (b).

20. The method of claim 3, wherein the match score is additionally based on the similarity of mass spectral data in step (b).
